(19) United States
(12) Patent Application Publication
(10) Pub. No.: US 2004/0173685 A1
(43) Pub. Date: Sep. 9, 2004

(54) Printed matter, information acquiring method, information acquiring system, information resource and computer-oriented program

(75) Inventors: Shinichi Imade, Iruma-shi (JP); Shinzo Matsui, Kitatsuru-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Optical Co., Ltd., Tokyo (JP)

(21) Appl. No.: 10/796,945

(22) Filed: Mar. 9, 2004

Related U.S. Application Data
(63) Continuation of application No. 10/132,493, filed on Apr. 25, 2002, now abandoned.

(30) Foreign Application Priority Data
May 15, 2001 (JP) 2001-145119

(51) Int. Cl. G06K 19/00; G06F 17/00

(52) U.S. Cl. 235/487; 235/375

(57) ABSTRACT

A second set of information that is detailed information is printed as an optically readable coded image near a visually readable first set of information that is basic information. As the coded image is read by an access device, the second set of information is restored and output in a perceptible form. The coded image is made to additionally contain output control information for outputting information necessary for inputting of instructions for causing the access device to operate for accessing an external information resource providing site, obtaining a third set of information that is updating information and outputting the third set of information in a perceivable format, when the second set of information restored by the access device is output. The person who wants to acquire information can acquire the third set of information on an on line basis by utilizing the information necessary for inputting instructions for the operation.

### CROSS-REFERENCE TO RELATED APPLICATIONS

The present application is a continuation application of U.S. application Ser. No. 10/132,493, filed Apr. 25, 2002 which is based upon and claims the benefit of priority from the prior Japanese Patent Application No. 2001-145119, filed May 15, 2001, the entire contents of which are incorporated herein by reference.

### BACKGROUND OF THE INVENTION

1. Field of the Invention

This invention relates to a printed matter carrying a visually recognizable image formed by characters, signs, figures, painted pictures, photographic pictures and/or computer graphics and a coded image that is obtained by coding data so as to be optically read by a reading device. The present invention also relates to an information acquiring method and an information acquiring system adapted to utilize such a printed matter. The present invention further relates to an information resource to be utilized by such an information acquiring system. Furthermore, the present invention relates to a computer-oriented program adapted to make a computer realize the functions of such an information acquiring system.

2. Description of the Related Art

Printed matters made of a medium printed with a visually recognizable image formed by characters, signs, figures, painted pictures, photographic pictures and/or computer graphics and a coded image such as a one- or two-dimensional bar code that is obtained by coding data including sound data, image data and data that can be handled by a computer such as text data so as to make it optically readable are known. For example, U.S. Pat. No. 5,896,403 describes such printed matter.

With a printed matter as disclosed in the above identified U.S. patent document, it is possible to provide the user with a large amount of various pieces of information as a result of a synergetic effect of information as a visually recognizable image and the various pieces of information contained in a coded image, both of which are printed on a medium. Additionally, it is possible to link such a printed matter and an information processing device such as a computer. Therefore, there may be various scenes where people utilize such printed matters in the so-called information age to come.

Particularly, at present, it is possible for people to easily acquire various pieces of information by accessing information resources (such as those called Web pages or home pages) on the World Wide Web (to be referred to as WWW hereinafter) implemented on the Internet, which is a worldwide telecommunications network, by means of an access device such as a personal computer or portable terminal device.

In view of these circumstances, there have been proposed techniques, including the one described in U.S. Pat. No. 5,640,193, for optically reading a URL (Uniform Resource Locator) provided in the form of a bar code on a printed matter by mean of a reading device so that the user may easily access an information resource corresponding to the URL by means of an access device to which the reading device is connected.

Incidentally, a URL is expressed by a string of characters such as http://www.*****.**.jp, of which http stands for the title of a protocol and www.*****.**.jp stands for the name of the server on the WWW that belongs to the information provider. A folder name or a file name may be put after www.*****.**.jp.

Therefore, the person who wants to access the information resource corresponding to the URL can actually access it with ease simply by optically reading the bar code by means of a reading device when an access device is connected to the reading device. Then, the person who accesses the information resource can acquire any desired pieces of information from the information resource. In this way, a printed matter and an information processing device can be easily linked to each other.

However, with the technique disclosed in U.S. Pat. No. 5,640,193, as the user sees the visually readable image on a printed matter and reads the corresponding bar code, the access device immediately starts accessing the information resource specified by the bar code. In other words, the above identified technique is not designed to allow the user consider if he or she really needs to access the information resource and acquire the information in the information resource or not. Therefore, the above identified technique needs improvements.

While this sort of problem may be dissolved by increasing the volume of information contained in the visually readable image printed on the printed matter, such a measure may by turn give rise to other problems including additional restrictions that may be imposed on the layout of the visually readable image on the printed matter because of the limited space of the printed matter. Then, the advantage of a printed matter of allowing the reader to visually and quickly detect the information he or she wants at a glance may be damaged, if partly.

### BRIEF SUMMARY OF THE INVENTION

In view of the above identified circumstances, therefore, it is an object of the present invention to provide a printed matter having both the advantage of a printed matter of allowing the reader to visually and quickly detect the information he or she wants at a glance and that of an information acquiring system utilizing a telecommunication network of allowing the user to remotely acquire information in combination so that the user may select in stages pieces of information he or she really wants. It is another object of the present invention to provide an information acquiring method and an information acquiring system adapted to utilize such a printed matter, an information resource to be utilized by such an information acquiring system and a computer-oriented program adapted to make a computer to the functions of such an information acquiring system.

According to a first aspect of the present invention, there is provided a printed matter comprising:

a first set of information containing at least one of characters, signs, graphics, painted pictures, photographic pictures and computer graphic printed in a form of visually readable; and

a second set of information obtained by coding data and printed in a form of a coded image optically readable to a reading device, the second set of information being different from the first set of information, wherein

the coded image further including:

output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of operation of the reading device of optically reading out the coded image, restoring the second set of information from the read out coded image and making the output unit of the access device adapted to access the external information resource by way of a telecommunication network output the restored second set of information in a perceivable form.

According to a second aspect of the present invention, there is provided an information acquiring method comprising:

reading a coded image from a printed matter by a reading device and restoring a second set of information and output control information from the coded image read by the reading device, the printed matter comprising a first set of information containing at least one of characters, signs, graphics, painted pictures, photographic pictures and computer graphic printed in a form of visually readable and the second set of information obtained by coding data and printed in a form of the coded image optically readable to the reading device, the second set of information being different from the first set of information, the coded image further including the output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of the operation of the reading-device of optically reading out the coded image, restoring the second set of information from the read out coded image and making the output unit of the access device adapted to access the external information resource by way of a telecommunication network output the restored second set of information in a perceivable form; and

outputting the restored second set of information. in a form perceivable from the output unit and also the information for inputting instructions necessary for the above operation on the basis of the restored output control information from the output unit.

According to a third aspect of the present invention, there is provided an information acquiring system comprising:

a reading device for optically reading a coded image from a printed matter comprising a first set of information containing at least one of characters signs, graphics, painted pictures, photographic pictures and computer graphic printed in a form of visually readable and a second set of information obtained by coding data and printed in a form of the coded image optically readable to the reading device, the second set of information being different from the first set of information, wherein the coded image further including output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of the operation of the reading device of optically reading out the coded image, restoring the second set of information from the read out coded image and making the output unit of the access device adapted to access the external information resource by way of a telecommunication network output the restored second set of information in a perceivable form;

a restoring unit for restoring the second set of information and the output control information from the coded image read by the reading device; and

a control unit for outputting the restored second set of information in a form perceivable from the output unit and also the information for inputting instructions necessary for the above operation on the basis of the restored output control information from the output unit.

According to a fourth aspect of the present invention, there is provided an information resource to be used with a printed matter comprising a first set of information containing at least one of characters, signs, graphics, painted pictures, photographic pictures and computer graphic printed in a form of visually readable and a second set of information obtained by coding data and printed in a form of a coded image optically readable to a reading device, the second set of information being different from the first set of information, wherein the coded image further including output control information for making an output unit of an access device output information for necessary inputting instructions for causing the access device to perform a sequence of operation of accessing the information resource, obtaining a third set of information different from the first and second sets of information from the information resource and making the output unit output the obtained third set of information in a perceivable form at the time of the operation of the reading device of optically reading out the coded image, restoring the second set of information from the read out coded image and making the output unit of the access device adapted to access the information resource by way of a telecommunication network output the restored second set of information in a perceivable form, the second set of information and the output control information being restored as a result of reading the coded image;

the restored second set of information being output in a form perceivable from the output unit, the information for inputting instructions necessary for the operation being output by the output unit according to the restored output control information; and

the information resource being accessed by the access device by way of a telecommunication network by utilizing the information for inputting instructions necessary for the operation output by the output unit,

the information-resource comprising:

a communication unit for communicating with the access device by way of the telecommunication network; and

a memory unit for storing the third set of information corresponding to the information for inputting instructions necessary for the operation.

According to a fifth aspect of the present invention, there is provided a program for causing a computer to realize:

a function of reading a coded image from a printed matter by a reading device and restoring a second set of information and output control information from the coded image read by the reading device, the printed matter comprising a first set of information containing at least one of characters, signs, graphics, painted pictures, photographic pictures and computer graphic printed in a form of visually readable and the second set of information obtained by coding data and printed in a form of the coded image optically readable to the reading device, the second set of information being different from the first set of information, the coded image further including the output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of the operation of the reading device of optically reading out the coded image, restoring the second set of information from the read out coded image and making the output unit of the access device adapted to access the external information resource by way of a telecommunication network output the restored second set of information in a perceivable form; and

a function of outputting the restored second set of information in a form perceivable from the output unit and also the information for inputting instructions necessary for the above operation on the basis of the restored output control information from the output unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention and, together with the general description given above and the detailed description of the embodiments given below, serve to explain the principles of the invention.

FIG. 1 is a schematic illustration of the first embodiment of the invention;

FIG. 2 is a schematic illustration of the operation of the first embodiment when the printed matter is an information magazine or a newspaper;

FIG. 3 is a schematic block diagram of an access device;

FIG. 4 is a schematic illustration of the contents of the data recorded in a coded image;

FIG. 5 is a flowchart of an information acquiring operation;

FIG. 6 is a schematic illustration of the operation of the first embodiment when the printed matter is a business card or a post card;

FIG. 7 is a schematic block diagram of a system for acquiring the personal information printed on a business card or a post card, illustrating the system configuration;

FIG. 8 is a list of pieces of personal information classified as the first through third sets of information that may be acquired from a business card or a post card;

FIG. 9 is a schematic illustration of the operation of the first embodiment when the printed matter is a personal identification such as a passport;

FIG. 10 is a schematic block diagram of a system for acquiring the personal information printed on a personal identification such as a passport, illustrating the system configuration;

FIG. 11 is a list of pieces of personal information classified as the first through third sets of information that may be acquired from a personal identification such as a passport;

FIG. 12 is a schematic illustration of the operation of the first embodiment when the printed matter is an information magazine showing events;

FIG. 13 is a list of pieces of information classified as the first through third sets of information that may be acquired from an information magazine showing events or a handout;

FIG. 14 is a list of pieces of information classified as the first through third sets of information that may be acquired from a rental video information leaflet that can be used for the first embodiment;

FIG. 15 is a list of pieces of information classified as the first through third sets of information that may be acquired from a compact disc catalog that can be used for the first embodiment;

FIG. 16 is a schematic block diagram of an access device that can be used for the second embodiment of the invention;

FIG. 17 is a main flowchart of the operation of the access device of FIG. 16;

FIG. 18 is a memory map of the RAM in FIG. 16;

FIG. 19 is a schematic illustration of a used car information magazine that can be used for the second embodiment of printed matter according to the second embodiment of the invention;

FIG. 20 is a schematic illustration showing how the display output changes for a used car information magazine to be used for the second embodiment of printed matter;

FIG. 21 is a list of pieces of information classified as the first through third sets of information that may be acquired from a used car information magazine to be used for the second embodiment of printed matter;

FIG. 22 is a schematic illustration of a mail order sale catalog that can be used for the second embodiment of printed matter;

FIG. 23 is a schematic illustration showing how the display output changes for a mail order sale catalog to be used for the second embodiment of printed matter;

FIG. 24 a list of pieces of information classified as the first through third sets of information that may be acquired from a mail order sale catalog to be used for the second embodiment of printed matter;

FIG. 25 is a schematic illustration of a hotel guide magazine that can be used for the second embodiment of printed matter;

FIG. 26 is a schematic illustration showing how the display output changes for a hotel guide magazine to be used for the second embodiment of printed matter;

FIG. 27 is a list of pieces of information classified as the first through third sets of information that may be acquired from a hotel guide magazine to be used for the second embodiment of printed matter;

FIG. 28 is a list of pieces of information classified as the first through third sets of information that may be acquired from a stock market newspaper to be used for the second embodiment of printed matter;

FIG. 29 is a schematic illustration of a stock market newspaper that can be used for the second embodiment of printed matter; and

FIG. 30 is a schematic illustration showing how the display output changes for a stock market newspaper to be used for the second embodiment of printed matter.

### DETAILED DESCRIPTION OF THE INVENTION

Now, the present invention will be described in greater detail by referring to the accompanying drawings that illustrate preferred embodiments of the invention.

[1st Embodiment]

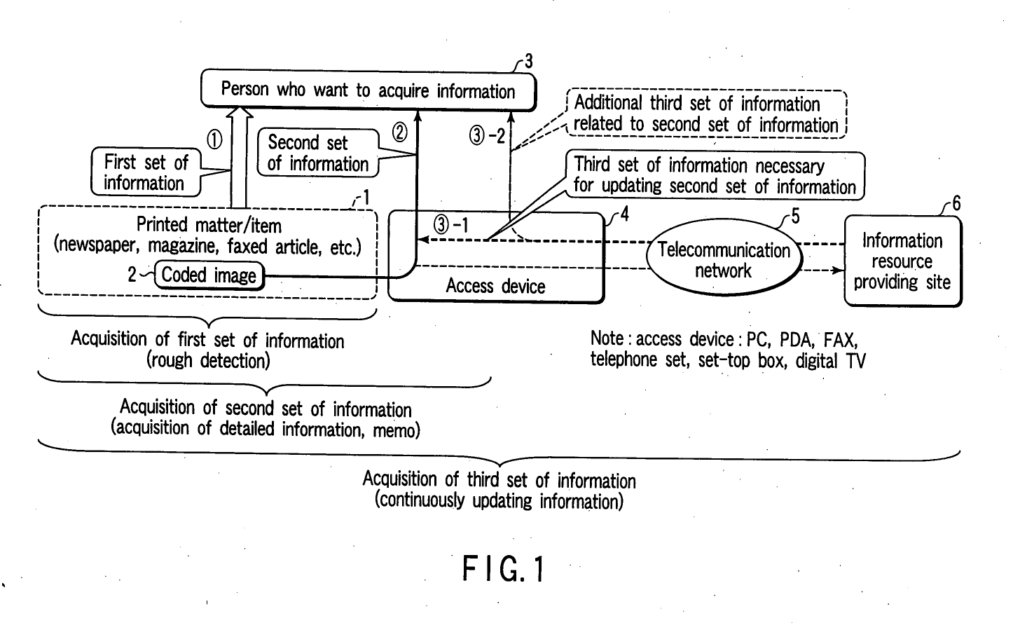

FIG. 1 is a schematic illustration of the first embodiment of the invention.

A first set of information is printed as a visually readable image formed by characters, signs, figures, painted pictures, photographic pictures and/or computer graphics on a printed matter/item 1 which may be a newspaper, magazine or a faxed article. Additionally, a second set of information is also printed on the printed matter/item 1 in the form of a coded image 2 that is different from the first set of information and obtained by coding data so as to be optically read by a reading device. The second set of information is detailed information relating to the first set of information that cannot be printed in the form of a visually readable image because of its volume. The coded image 2 that corresponds to the visually readable image is arranged near the latter on the printed matter/item 1.

A person 3 who wants to acquire the information can obtain the first set of information by reading the visually readable image on the printed matter/item 1. If the person wants to acquire detailed information relating to the first set of information, he or she reads the coded image 2 located near the visually readable image by means of an access device 4 provided with a reading device (not shown). As far as this specification is concerned, an access device 4 refers to a device provided with a function of accessing an information resource providing site 6 by way of a telecommunication network 5 such as the Internet. The access device 4 may be a personal computer (PC), a PDA (Personal Data Assistant), a fax machine, a (cellular) telephone set, a set-top box or a digital TV set. The access device 4 is provided with a function of restoring the second set of information from the coded image 2 it has read and outputting the restored second set of information in a perceptible form by the output unit (not shown) it comprises.

The coded image 2 contains coded output control information in addition to the second set of information. The output control information is used to make the output unit output information necessary for inputting instructions for driving the access device 4 to perform an operation of accessing the external information resource providing site 6, obtaining a third set of information different from the first and second sets of information and outputting the obtained third set of information in such a form that the user can easily perceive it. The third set of information may be information that is obtained most recently and with which the second set of information needs to be updated and/or other additional information relating to the second set of information.

The person 3 who wants to acquire information perceives the second set of information output in a perceivable form. Subsequently as the information necessary for inputting instructions for the above operation is output by the output unit of the access device 4 according to the output control information, the person 3 actually gives instructions for the above operation to the access device 4. As a result, the access device 4 accesses the information resource providing site 6 by way of the telecommunication network 5 and obtains the third set of information to output it.

In this way, the person 3 who wants to retrieve and acquire the information in which he or she is interested can detect it easily in a short period of time by acquiring the first set of information arranged on the printed matter/item 1 that the person 3 can easily grasp at a glance. Thus, the person 3 can roughly detect the information by way of the visually readable image. Then, since the coded image is provided around the first set of information and contains detailed information related to the detected first set of information, it is now possible to obtain detailed secondary information as a normal step of information acquisition. It will be appreciated that the obtained secondary information reflects the person's intention of selectively acquiring information on the basis of the primary information that belongs to that person 3. In other words, any situations where a large amount of unnecessary readable information is randomly provided to the person 3 can be effectively avoided. Particularly, the space for accommodating information on the printed matter/item 1 can be reduced to save the precious natural resource of paper as the coded image 2 is provided on the printed matter/item 1. Additionally, because the coded image 2 contains output control information to be used to make the output unit output information necessary for inputting instructions for driving the access device 4 to obtain updated information by way of a telecommunication network on an on line basis in addition to the second set of information, the person 3 who wants to acquire information can selectively use a means for acquiring most updated information to offset the weak point of paper medium.

Therefore, the first embodiment can provide a process of selectively acquiring the information in stages that the user wants by means of an optimal combination of the advantages of a paper medium and those of an on-line telecommunication means. Additionally, the first embodiment can provide a process for enabling to optimally exploit the advantage of the paper medium of allowing the user to acquire the information he or she wants at glance, that of a code of providing detailed information if necessary and that of a telecommunication network of providing information on an on line basis.

Now, the first embodiment will be described in greater detail by way of examples.

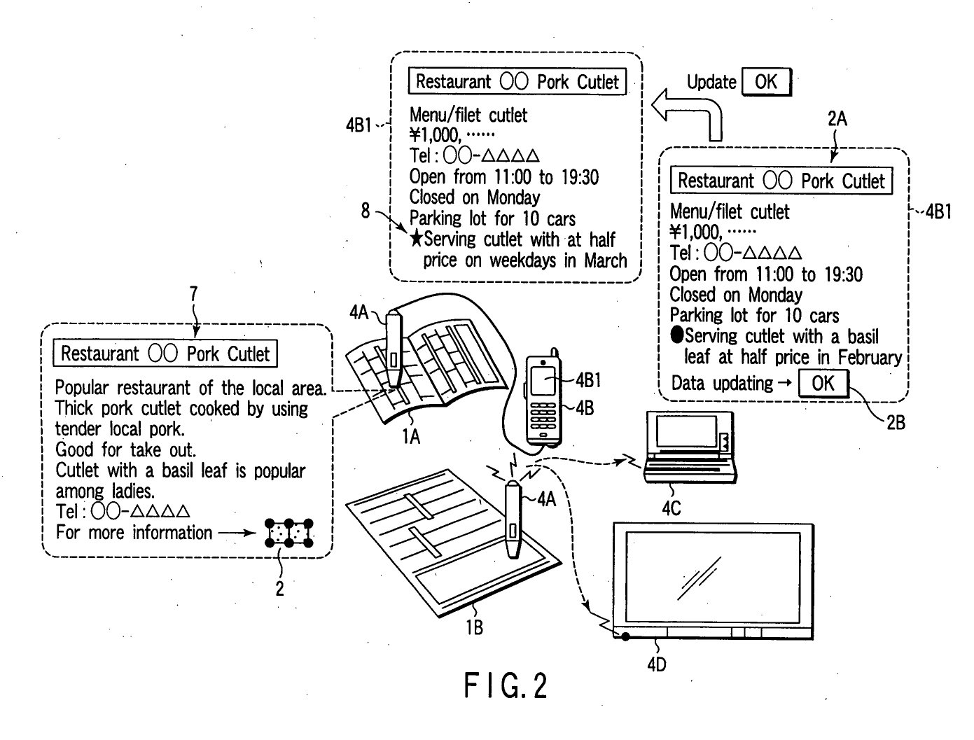

FIG. 2 is a schematic illustration of the operation of the first embodiment when the printed matter/item 1 is an information magazine 1A or a newspaper 1B. Referring to FIG. 2, the access device 4 comprises a reading device 4A for reading the coded image 2 and a cellular telephone set 4B connected to the reading device 4A by way of a wire. Alternatively, it may be so arranged that the cellular telephone set 4B contains the reading device 4A inside. Still alternatively, the access device 4 may comprise a reading device 4A and a PC 4C or a digital TV set 4D connected to a reading device 4A by way of or without a wire.

A first set of information is printed as a visually readable image 7 formed by characters, signs, figures, painted pictures, photographic pictures and/or computer graphics on a printed matter/item 1, which may be an information magazine 1A or a newspaper 1B. The first set of information may be one or more than one articles or advertisements. Additionally, a coded image 2 is printed near the visually readable image 7. As the coded image 2 is read by the reading device 4A, the second set of information 2A that is detailed information restored from the code image 2 is displayed on display 4B1 of the cellular telephone set 4B. At the same time, an image for information necessary for driving the access device 4 to perform an operation (e. g., link icon 2B) is also displayed on the basis of the output control information that is also restored from the coded image 2.

As the link icon 2B (“OK”) is clicked by a predetermined key operation on the cellular telephone set 4B, a corresponding third set of information is obtained from information resource providing site 6 as updating information (on the service menu of March in the example of FIG. 2) and displayed on the display 4B1 of the cellular telephone set 4B by the tele-communication function of the cellular telephone set 4B. Then, the second set of information 2A that is being displayed on the display 4B1 of the cellular telephone set 4B is updated by the obtained third set of information 8.

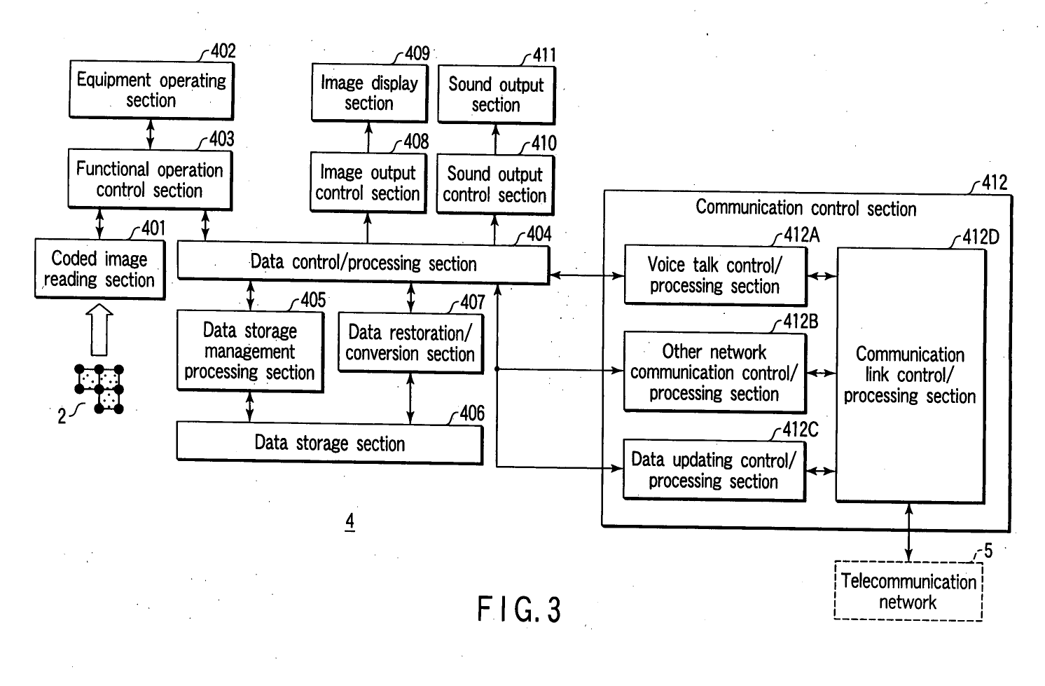

FIG. 3 is a schematic functional block diagram of the access device 4 adapted to operate in a manner as described above. The access device 4 comprises a coded image reading section 401, an equipment operating section 402, a functional operation control section 403, a data control/processing section 404, a data storage management processing section 405, a data storage section 406, a data restoration/conversion section 407, an image output control section 408, an image display section 409, a sound output control section 410, a sound output section 411 and a communication control section 412. The above reading device 4A may include the coded image reading section 401, the equipment operating section 402, the functional operation control section 403, the data control/processing section 404, the data storage management section 405, the data storage section 406 and the data restoration/conversion section 407. Of course, the configuration of the reading device 4A is not limited thereto, although it is required to include at least the coded image reading section 401, the equipment operating section 402 and the functional operation control section 403.

The coded image reading section 401 is adapted to read a coded image 2 and its operation is controlled by the functional operation control section 403 according to the operation of the equipment operating section 402 that may typically include a reading switch.

The data control/processing section 404 temporarily stores the image data of the coded image 2 read by the reading device 4A in the data storage section 406 by way of the data storage management section 405. The data restoration/conversion section 407 reads out the image data stored in the data storage section 406 and restores the second set of information and the output control information. If the restored second set of information is image information, the data control/processing section 404 outputs and displays the image information on the image display section 409 that may typically be a liquid crystal display by way of the image output control section 408. If, on the other hand, the restored second set of information is sound information, the data control/processing section 404 outputs the sound information from the sound output section 411 that may typically be a loudspeaker by way of the sound output control section 410.

When the data control/processing section 404 outputs the second set of information to the image display section 409 and/or the sound output section 411, it also outputs the information necessary for inputting instructions for the operation according to the restored output control information. More specifically, the information necessary for inputting instructions for the operation is provided in the form of an image (link icon 2B) for inputting instructions for the operation when the data control/processing section 404 outputs the information necessary for inputting instructions for the operation to the image display section 409, whereas it is provided in the form of a sound for inputting instructions for the operation when the data control/processing section 404 outputs the information to the sound output section 411.

When the person 3 who wants information desires to acquire the third set of information, he or she clicks the link icon 2B by means of the equipment operating section 402 to input a necessary instruction. Then, the data control/processing section 404 accesses the corresponding information resource providing site 6 to acquire the third set of information according to the communication control information (which will be described in greater detail hereinafter) contained in the coded image 2 by way of the telecommunication network 5 under the control of the communication control section 412.

The communication control section 412 comprises a voice talk control/processing section 412A, an other network communication control/processing section 412B, a data updating control/processing section 412C and a communication link control/processing section 412D.

The voice talk control/processing section 412A controls and processes the operation of the device for ordinary voice communications. With this functional feature, if necessary, the user can enquire the telephone number he or she needs to dial in order to acquire the third set of information by means of the voice talk control/processing section 412A instead of clicking the link icon 2B to input an instruction for that purpose. The other network communication control/processing section 412B is designed to be used by the user to make enquiries on the bases of the second set of information typically by e-mail. The data updating control/processing section 412C is used by the user to acquire the third set of information and update part or all of the second set of information. The communication link control/processing section 412D is used for actually linking the reading device 4A and the telecommunication network 5.

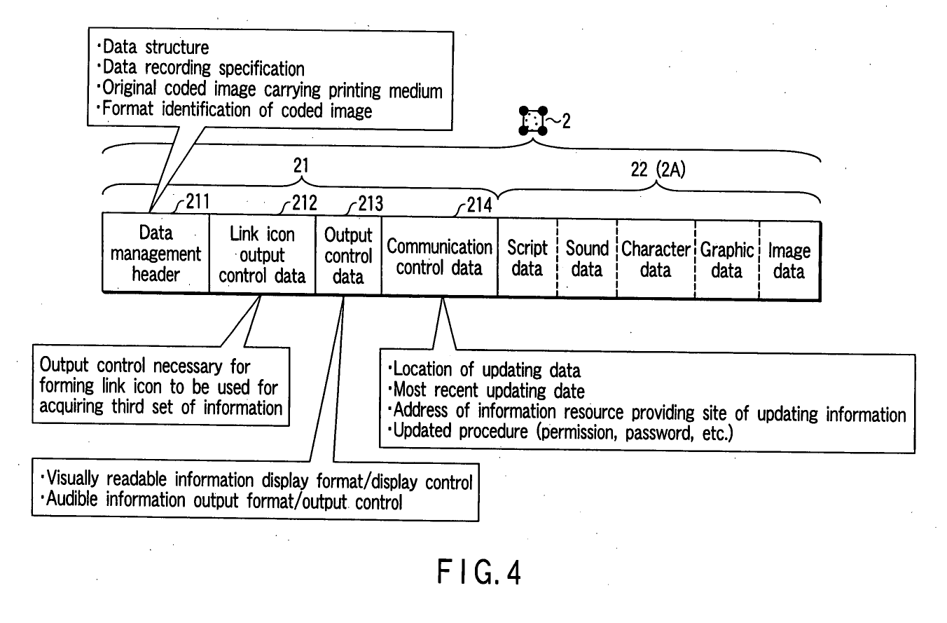

FIG. 4 is a schematic illustration of the contents of the data recorded in a coded image 2. As seen from FIG. 4, the coded image 2 includes control information 21 and output information 22. The output information 22 corresponding to the second set of information contains an appropriate combination of script data, sound data, character data, graphic data, picture data and so on.

The control information 21 contains a data management header 211, a link icon output control data 212, an output control data 213 and a communication control data 214. The data management header 211 by turn contains, for example, information on the configuration of the data recorded in the coded image 2, information on the data recording specification of the coded image 2, information on the date and the page number of the printing media such as newspaper or magazine from which the coded image originates and information necessary for identifying the format of the coded image 2. The link icon output control data 212 contains the output control information necessary for forming a link icon to be used for acquiring the third set of information. The output control data 213 contains information on the layout of the visually readable information, information for controlling the display and information on the output format of and for controlling the output of audible information. The communication control data 214 contains information on the part of the second set of information to be updated, the date of the last updating operation, the site address of the source of the last update and information on the updating procedure (need or non-need of permission, password, etc.).

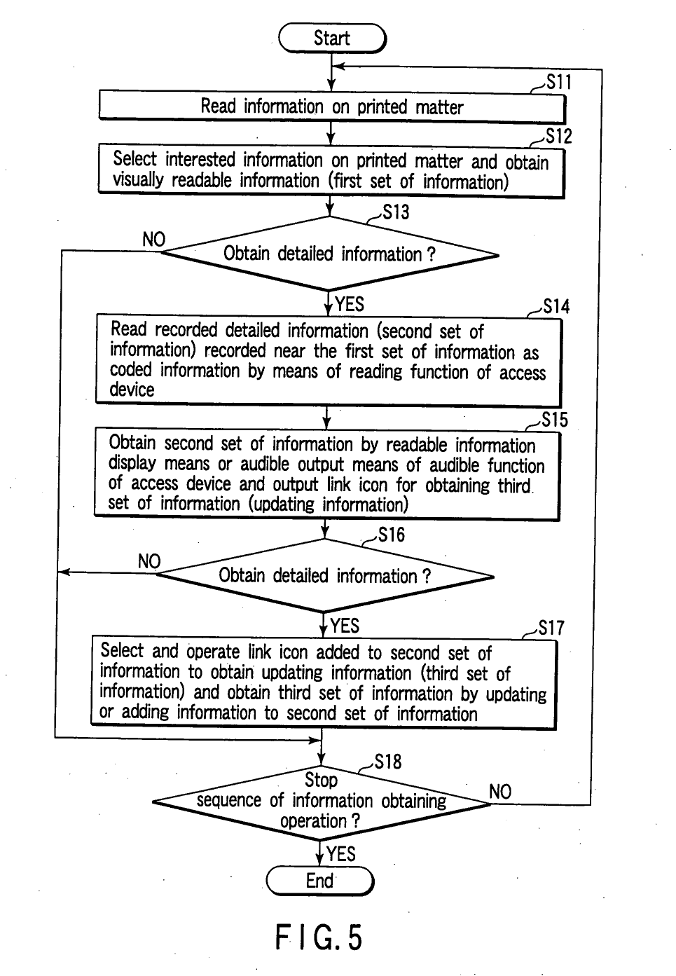

FIG. 5 is a flowchart of an information acquiring operation of the embodiment.

Referring to FIG. 5, firstly the person 3 who wants to acquire information reads the information on the printed matter 1 that may be an information magazine 1A or a newspaper 1B (Step S11). The person 3 then selects a set of information on the printed matter in which he or she is interested and actually acquires the readable information 7 (first set of information) (Step S512).

Then, the person 3 determines if he or she wants detailed information for the first set of information or not (Step S13). If the person 3 does not wants detailed information, the operation skips to Step S18, which will be described hereinafter.

If, on the other hand, the person 3 wants detailed information, he or she drives the access device 4 to make it read the detailed information (second set of information 2A) recorded as coded image 2 near the acquired first set of information (Step S14).

As a result, the access device 4 obtains the second set of information 2A by using the readable information display unit (image display section 409) or the audible information output unit (sound output section 411) and outputs a link icon 2B to be used for acquiring the third set of information 8 (updating information) (Step S15).

Then, the person 3 who wants to acquire information determines if he or she wants updating information or not (Step S16). If the person 3 does not want updating information, the operation skips to Step S18, which will be described hereinafter.

If, on the other hand, the person 3 wants updating information (the third set of information 8), he or she selects and clicks the link icon 2B provided as an annex to the second set of information. As a result, the access device 4 accesses the corresponding information resource providing site 6 by way of the telecommunication network 5 on the basis of the communication control data 214 in the control information 21 of the coded image 2 and obtains the third set of information 8, which may be used to update or added to the second set of information 2A (Step S17).

Thereafter, the person 3 who wants to acquire information determines if he or she wants to terminate the information acquiring operation or not (Step S18) and, if the person 3 wants to acquire additional information, he or she returns to Step S11. If, on the other hand, the person 3 wants to terminate the information acquiring operation, he or she simply ends the operation.

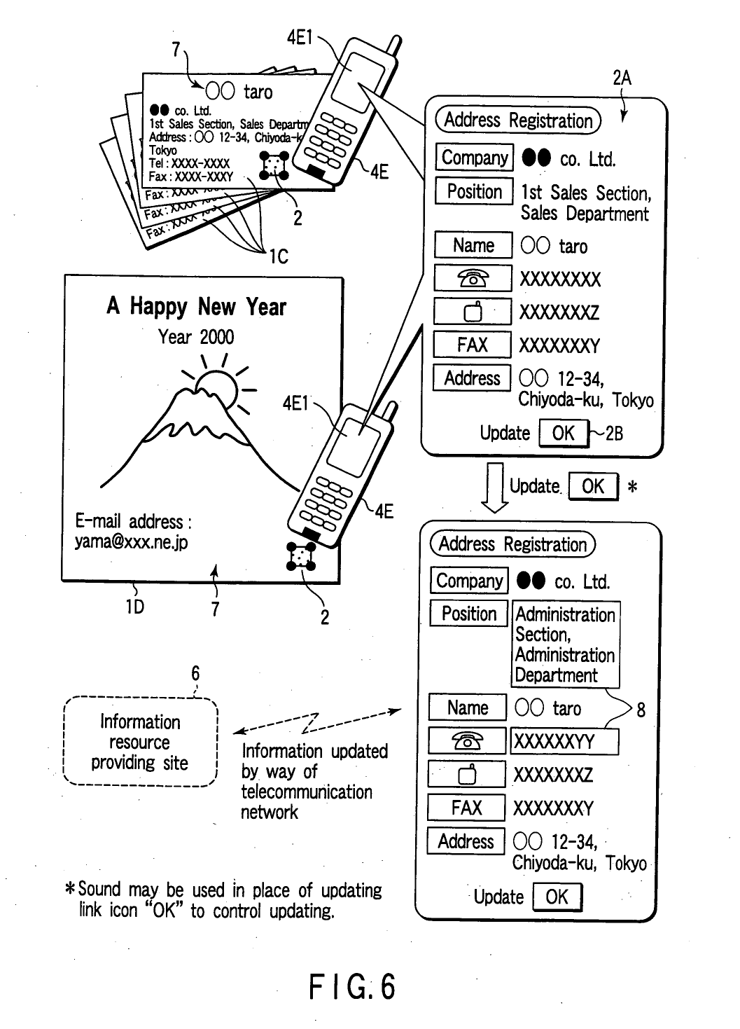

FIG. 6 is a schematic illustration of the operation of the first embodiment when the printed matter 1 is a business card 1C or a post card 1D.

Referring to FIG. 6, business card 1C carries thereon the name, the address and the telephone number of the card issuer and the name of the company and the department in the company to which the card issuer belongs as the visually readable image 7 (first set of information). Similarly, post card 1D carriers thereon the name and the address of the sender of the post card along with the message written by the sender as the visually readable image 7 (first set of information). Additionally, a coded image 2 containing the second set of information is printed near the visually readable image 7 on the business card 1C and the post card 1D.

As the coded image 2 is read by cellular telephone set 4E operating as an access device 4 having a code reading function, the second set of information 2A and a link icon 2B are displayed on the display 4E1 of the cellular telephone set 4E as shown in the upper right balloon in FIG. 6.

When the link icon 2B (“OK”) is clicked by operating a corresponding key of the cellular telephone set 4E, the latter obtains updating information from the information resource providing site 6 by way of the telecommunication network 5 and displays the third set of information as updating information.

The operation of clicking the link icon 2B (“OK”) for the updating operation may be replaced by a sound instruction for the updating operation. For example, it may be so arranged that the third set of information 8 is acquired as the user of the cellular telephone set 4E speaks a word of “update” to the telephone set 4E. Then, it may be so arranged that the cellular telephone set 4E outputs a voice message “Input a word of ‘update’.” from the loudspeaker thereof as guide information for inputting a voiced instruction for the operation instead of displaying a link icon 2B.

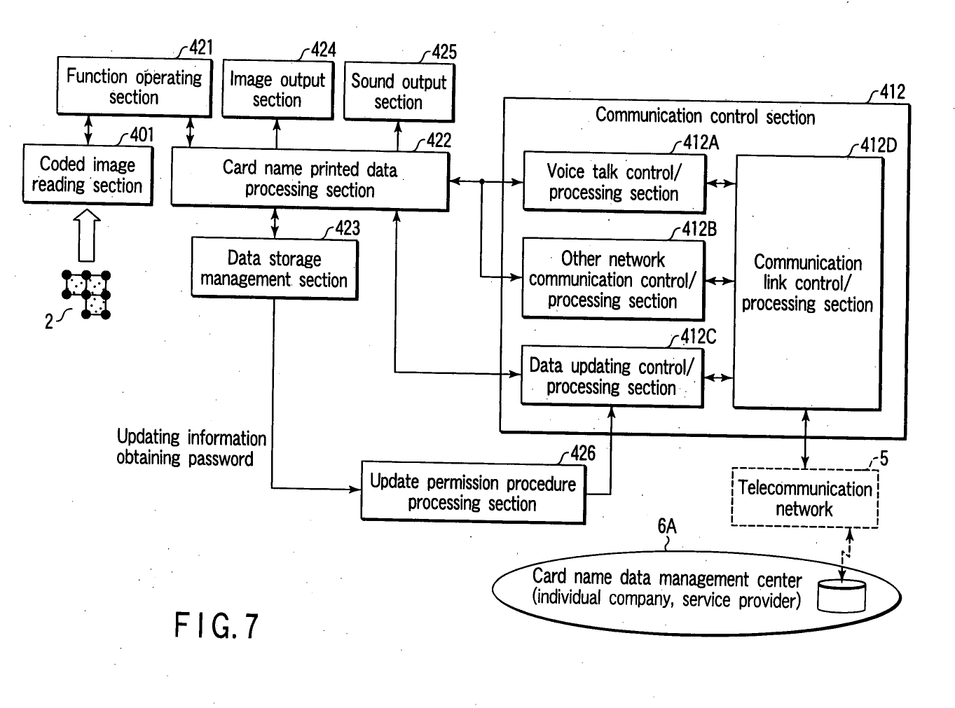

FIG. 7 is a schematic block diagram of a system for acquiring the personal information printed on a business card 1C or a post card 1D, illustration the system configuration. Referring to FIG. 7, a function operating section 421 operates both as the equipment operating section 402 and the functional operation control section 403 of FIG. 3. A business card printed data processing section 422 of FIG. 7 operates both as the data control/processing section 404 and the data restoration/conversion section 407 of FIG. 3. A data storage management section 423 of FIG. 7 operates both as the data storage management processing section 405 and the data storage section 406 of FIG. 3. An image output section 424 of FIG. 7 operates both as the image output control section 408 and the image display section 409 of FIG. 3. A sound output section 425 of FIG. 7 operates both as the sound output control section 410 and the sound output section 411 of FIG. 3.

In this example, the cellular telephone set 4E further comprises an update permission procedure processing section 426. The information resource providing site 6 of this example is a specific business card data management center 6A.

The business card printed data processing section 422 reads the detailed information on the business card 1C or the post card 1D as the coded image 2 and stores the information it has read in the data storage management section 423. Thereafter, the business card printed data processing section 422 restores the second set of information and outputs it from the image output section 424 and/or the sound output section 425. For obtaining updating information as the third set of information, the cellular telephone set 4E accesses the business card data management center 6A by means of the data updating control/processing section 412C of the communication control section 412 and by way of the communication link control/processing section 412D and the telecommunication network 5 as described earlier.

The business card data management center 6A always stores updated information. If a person receives a business card 1C or a post card 1D from another person, the former person stores the data on the card in the data storage management section 423 and obtains updating information from the business card data management center 6A because the department to which the second person belongs and the title of the second person might have been changed.

However, without appropriate precautionary measures, confidential personal information may be easily drawn to give rise to the problem of security of personal information. To cope with this problem, an updating information obtaining password input by way of the functional operation section 421 or registered in advance to the data storage management section 423 is given to the data updating control/processing section 412C by means of the update permission procedure processing section 426 and transmitted to the business card data management center 6A to find out if the person trying to acquire the updating information is eligible to do so or not.

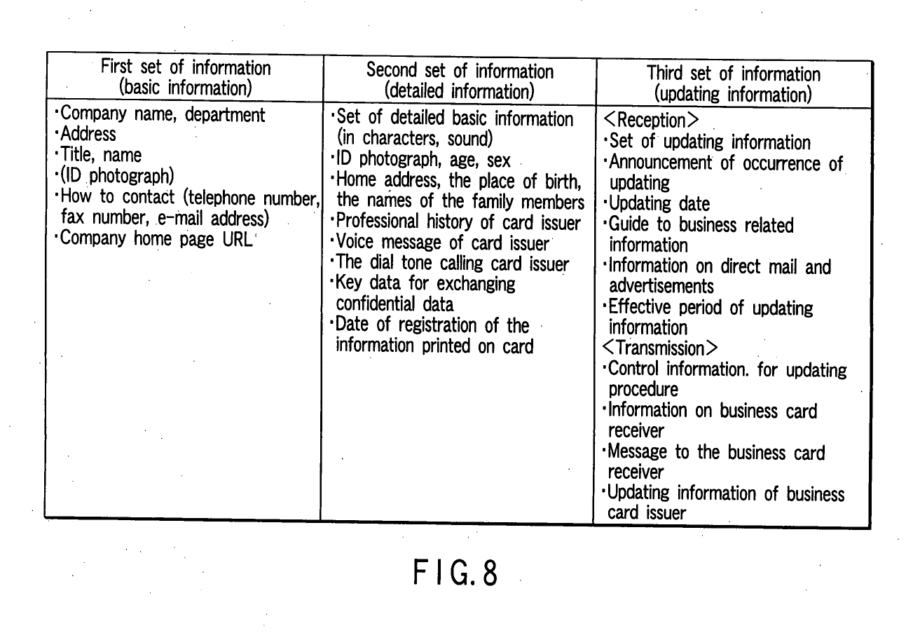

FIG. 8 is a list of pieces of personal information classified as the first through third sets of information that may be acquired from a business card 1C or a post card 1D.

Referring to FIG. 8, the first set of information that is basic information may include the name of the company and the department in the company to which the card issuer belongs; the address of the company; the title and name of the card issuer; a photograph of the card issuer if necessary; cues for making contact with the card issuer (telephone number, fax number, e-mail address, etc.); the URL of the home page of the company; etc.

The second set of information that is detailed information may include the entire or part of data of the first set of information provided in the form of characters and/or sound; a photograph, the age and the sex of the card issuer; the home address, the place of birth and the names of the family members; the professional history of the card issuer; a voice message of the card issuer; the dial tone calling the card issuer; a keyword for exchanging confidential data with the card issuer; the date of registration of the information printed on the card; etc.

The third set of information that is updating information may include a set of updating information (provided in the form of characters and/or sound); an automatic announcement of an occurrence of updating; the date of updating; a guide to business related information for the card issuer; information on the direct mail and the advertisements of the card issuers; the effective period of the updating information; etc.

While the third set of information is basically updating information of the issuer of the card, it is also possible for the person 3 who wants to acquire information to transmit his or her own updating information to the business card data management center 6A to make the latter store it. In other words, the person 3 who wants to acquire information can upload control information necessary for the updating procedure; information on the business card receiver; a message to the business card receiver; updating information of the business card issuer; etc. to the business card data management center 6A.

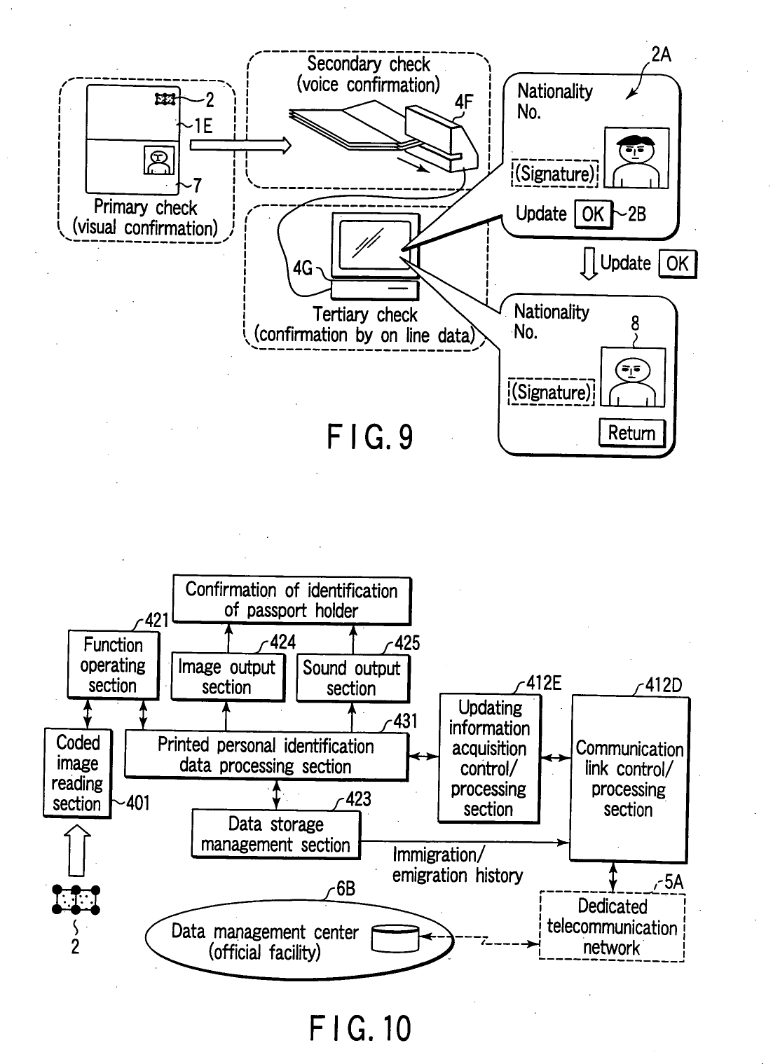

FIG. 9 is a schematic illustration of the operation of the first embodiment when the printed matter/item 1 is a personal identification 1E such as a passport. In this case, the access device 4 comprises a reading device 4F arranged at an emigration/immigration control gate and containing a reading section in a slit and a PC 4G connected to the reading device 4F. On the other hand, the personal identification 1E carries thereon a visually readable image 7 that includes a personal photograph of the passport holder and other information necessary for identifying the passport holder printed on it as the first set of information and a coded image 2 printed near the visually readable image 7.

Normally, the immigration officer performs a primary check by seeing the visually readable image 7 on the personal identification 1E.

If the immigration officer thinks that it is necessary to check the identification of the holder of the personal identification 1E in a more detailed way, he or she reads the coded image 2 on the personal identification 1E by moving the personal identification 1E through the slit of the reading device 4F. Assume that the coded image 2 contains a personal photograph of the holder of the personal identification 1E, biometric information on the part of the holder of the personal identification 1E, the voice of the holder of the personal identification 1E, etc. Then, while the part of the second set of information 2A that can be displayed may be actually displayed on the display of the PC 4G, it is assumed here that only voice information is utilized out of the restored second set of information for the secondary check because it is relatively less affected by the ageing of the holder of the personal identification 1E. That is, the sound output section of the PC 4G may output the restored voice, thus making the holder of the personal identification 1E speak same phrase of the restored voice, then compare two voices.

If the immigration officer thinks that it is necessary to check the identification of the holder of the personal identification 1E in a further detailed way, he or she checks the online data as the tertiary check. While the part of the second set of information 2A (a personal photograph and a signature of the holder of the personal identification 1E) obtained by restoring the coded image 2 that can be displayed may be actually displayed on the display of the PC 4G, it is assumed here that the immigration officer accesses a predetermined information resource providing site (the data management center in this case) to display the third set of information 8 as updating information and check the identity of the holder of the personal identification 1E on the basis of the updating information by clicking the link icon 2B to give an instruction for the operation because some part of the second set of information may become obsolete with time.

FIG. 10 is a schematic block diagram of the system for acquiring the personal information printed on a personal identification such as a passport, illustration the system configuration. Referring to FIG. 10, a printed personal identification data processing section 431 operates both as the data control/processing section 404 and the data restoration/conversion processing section 407. It will be appreciated that the voice talk control/processing section 412A and the other network communication control/processing section 412B are not necessary so that the system requires only an updating information acquisition control/processing section 412E that operates like the data updating control/processing section 412C. Then, data is obtained from a data management center 6B connected to the immigration office by a dedicated telecommunication network 5A by way of the communication link control/processing section 412D.

It is also possible to update the data of the data management center 6B by uploading the immigration/emigration history of the holder of the personal identification 1E to the data management center 6B from the data storage management section 423.

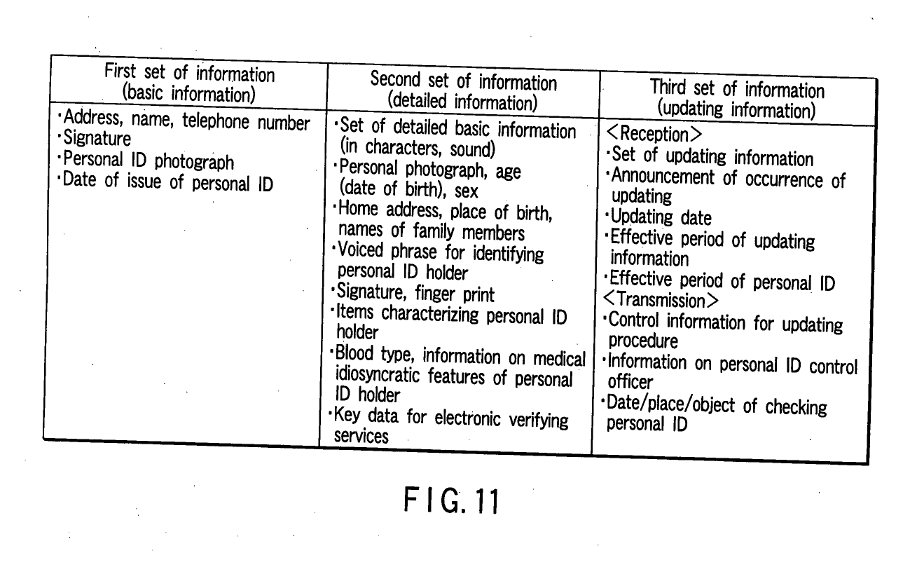

FIG. 11 is a list of pieces of personal information classified as the first through third sets of information that may be acquired from such a personal identification 1E.

As shown in FIG. 11, the first set of information that is basic information may include the address, the name and the telephone number; the signature; a personal photograph of the holder of the personal identification 1E; the date of issue of the personal identification 1E; etc.

The second set of information that is detailed information may include a set of basic information may include the entire or part of data of the first set of information provided in the form of characters and/or sound; a photograph, the age (date of birth) and the sex; the home address, the place of birth and the names of the family members; the voiced phrase for identifying the holder; the own signature and a finger print of the holder of the personal identification 1E; other characteristic items for identifying the holder of the personal identification 1E; the blood type and information on medical idiosyncratic features of the holder of the personal identification 1E; the key data to be used for electronic verifying services; etc.

The third set of information that is updating information may include may a set of updating information (provided in the form of characters and/or sound); an automatic announcement of an occurrence of updating; the date of updating; the effective period of the updating information; the last effective date of the personal identification 1E; etc. The third set of information to be transmitted to the data management center 6B may include control information for the updating procedure; information on the inspectors of the personal identification 1E; the dates/places/objects of inspections of the personal identification 1E; etc.

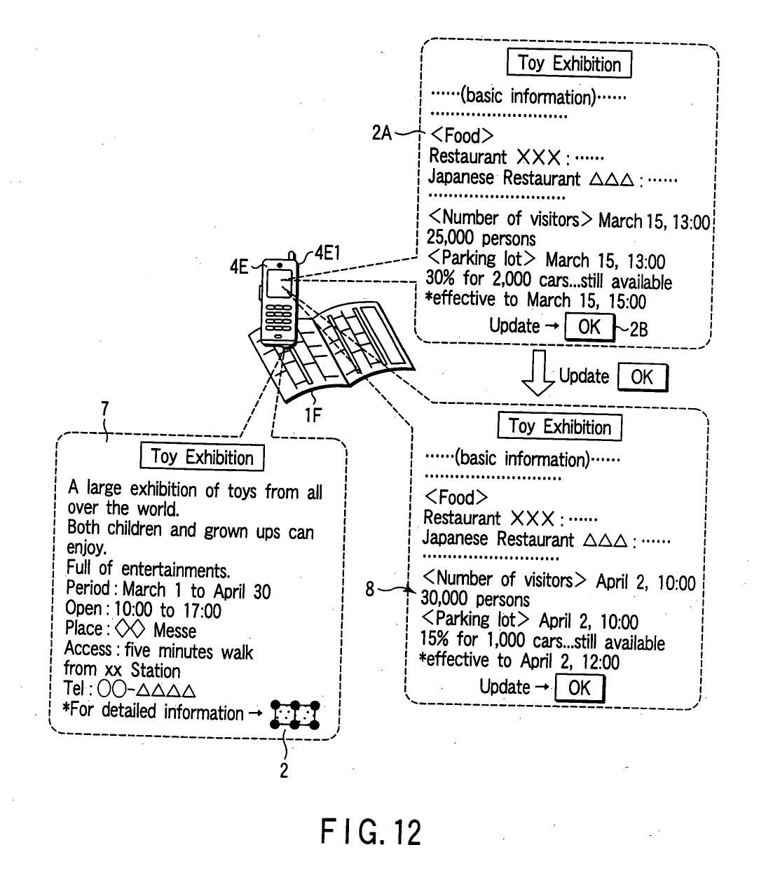

FIG. 12 is a schematic illustration of the operation of the first embodiment when the printed matter/item 1 is an information magazine 1F showing events. In this case, the second set of information 2A that is detailed information is displayed on the display 4E1 of the cellular telephone set 4E having a reading function. However, information whose contents can change incessantly such as information on the number of visitors, information on the available parking space, etc. needs to be constantly updated. Therefore, it will be necessary to access a predetermined information resource providing site 6 to update and display the third set of information 8 by clicking the link icon 2B as shown in FIG. 12.

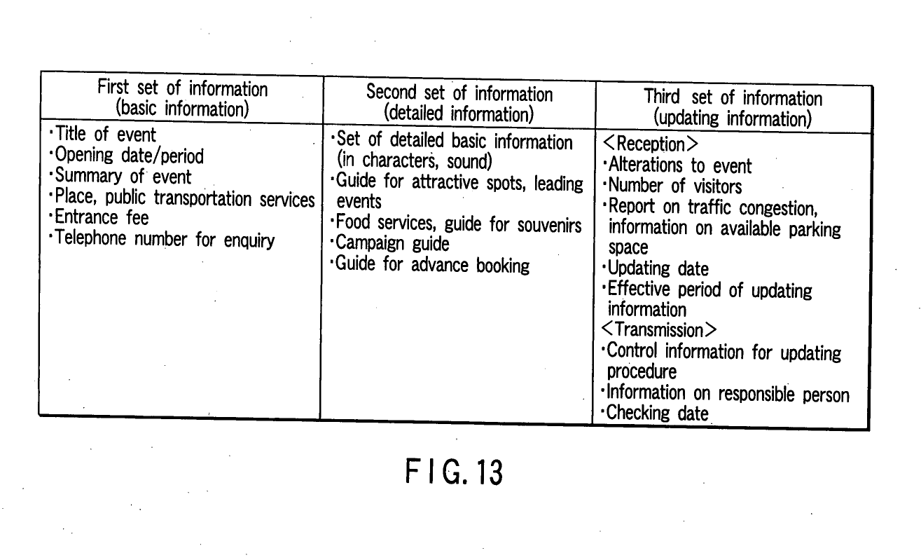

FIG. 13 is a list of pieces of information classified as the first through third sets of information that may be acquired from an information magazine 1F showing events or a handout.

As shown in FIG. 13, the first set of information that is basic information may include the title of each event; the opening date/period; the summary of event; the place and information on available transportation services; entrance fee; telephone number for enquire; etc.

The second set of information that is detailed information may include the entire data of the first set of information provided in the form of characters and/or sound; a guide for attractive spots and leading events; food services and a guide for souvenirs; a campaign guide; a guide for advance booking; etc.

The third set of information that is updating information may include alterations, if any, to the event; the current number of visitors; a report on the current traffic congestion and information on the available parking space; the date of updating; the effective period of the updating information; etc. The third set of information to be transmitted to the information resource providing site 6 may include control information necessary for the updating procedure; information on the person in charge for acquiring the updating information; the checking date; etc.

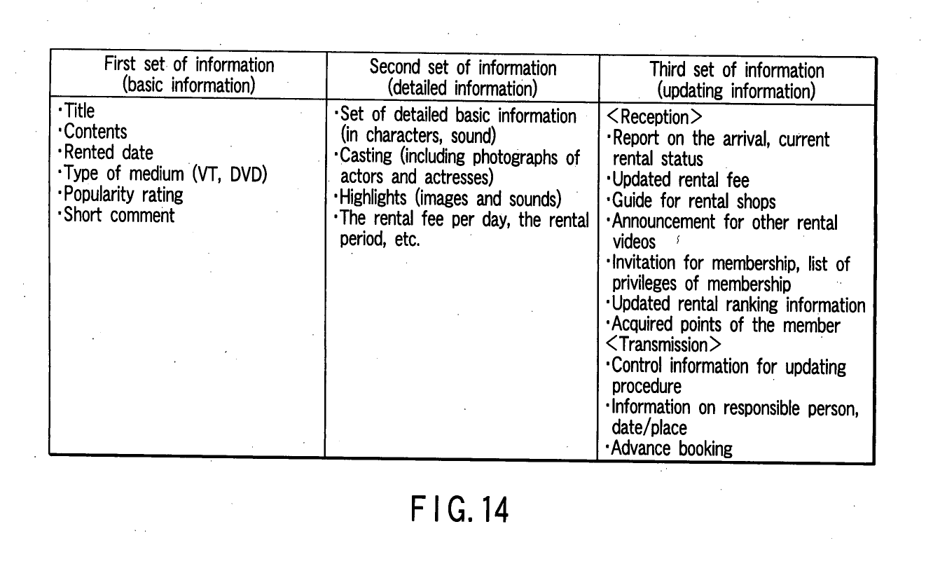

FIG. 14 is a list of pieces of information classified as the first through third sets of information that may be acquired from a printed matter/item 1 that is a rental video information leaflet.

As shown in FIG. 14, the first set of information that is basic information may include the title of each rental video; a summary of the contents; the day when the video is rented; the type of the medium (video tape (VT), DVD); the popularity rating; a short comment on the contents; etc.

The second set of information that is detailed information may include the entire data of the first set of information provided in the form of characters and/or sound; the casting (including photographs of actors and actresses); highlights (images and sounds); the rental fee per day and the rental period; etc.

The third set of information that is updating information may include a report on the arrival and the current rental status of the video; the updated rental fee if any; a guide for rental shops in the vicinity; an announcement for other rental videos; an invitation for membership and a list of privileges of membership; an updated rental ranking information; the acquired points of the member; etc. The third set of information to be transmitted to the information resource providing site 6 may include control information necessary for the updating procedure; information on the person, date and place in charge for acquiring the updating information; a report on advance booking; etc.

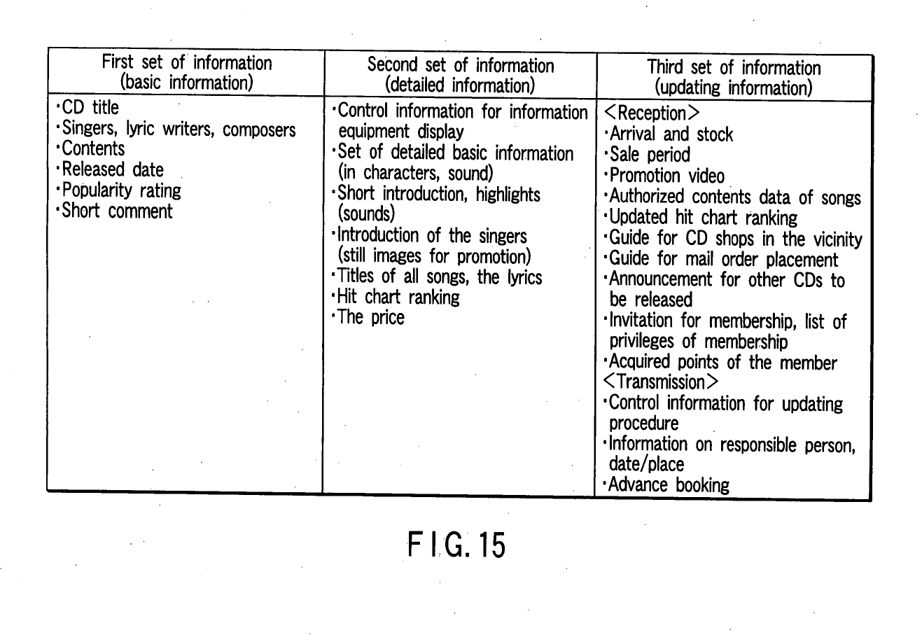

FIG. 15 is a list of pieces of personal information classified as the first through third sets of information that may be acquired from a printed matter/item 1 that is a catalog for mail order sales. It is assumed here that the catalog is for compact discs (CDs) to be sold by mail order.

As shown in FIG. 15, the first set of information that is basic information may include the CD titles; the singers, the lyric writers and the composers; a summary of the contents; the released date; the popularity rating; a short comment on the songs; etc.

The second set of information that is detailed information may include the control information for information equipment display; the entire data of the first set of information provided in the form of characters and/or voice; introductory parts and highlights (sounds); introduction of the singers (still images for promotion); the titles of all the songs and the lyrics; the hit chart ranking; the price; etc.

The third set of information that is updating information may include a report on the arrival and stock; the sale period; the promotion video for each CD if any; authorized contents data of the songs; the updated hit chart ranking; a guide for CD shops in the vicinity; a guide for mail order placement; an announcement for other CDs to be released; an invitation for membership and a list of privileges of membership; the acquired points of the member; etc. The third set of information to be transmitted to the information resource providing site 6 may include control information necessary for the updating procedure; information on the person, date and place in charge for acquiring the updating information; a report on advance booking; etc.

The description of the last example may also be applicable to sales of call informing melodies and standby images for cellular telephone sets.

[2nd Embodiment]

Now, the second embodiment of the invention will be described below, the second embodiment is adapted to provide the second set of information by means of a plurality of images.

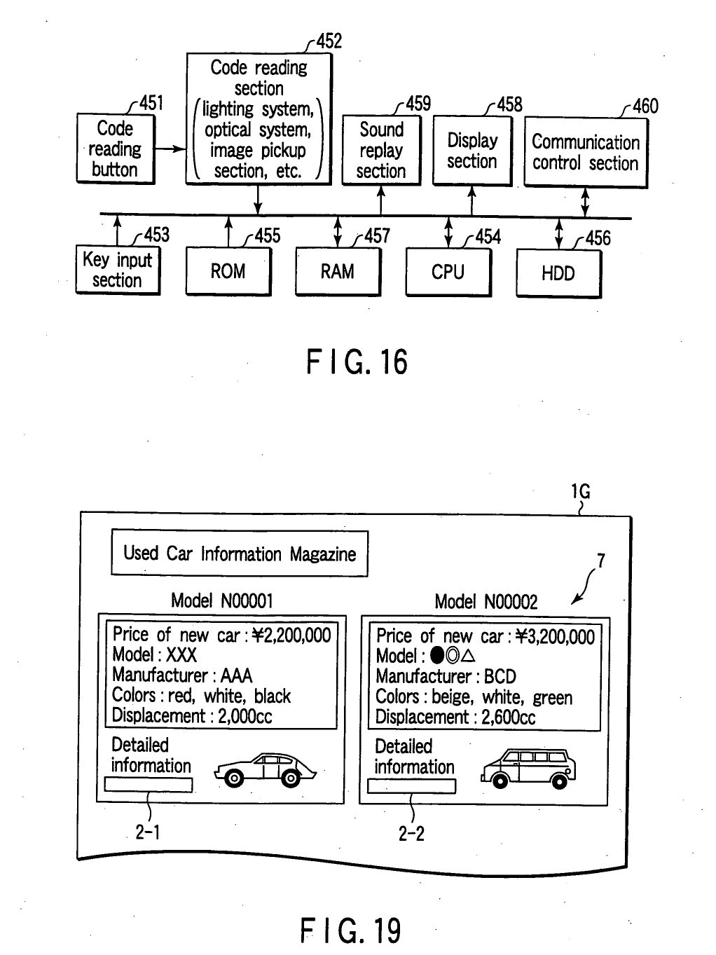

FIG. 16 is a schematic block diagram of an access device 4 that can be used for the second embodiment of the invention. The access device 4 comprises a code reading button 451, a code reading section 452, a key input section 453, a CPU 454, a ROM 455, a hard disk drive (HDD) 456, a RAM 457, a display section 458, a sound replay section 459 and a communication control section 460.

The code reading button 451 is used to give a command for reading coded image 2. It is automatically turned off when the code reading operation is terminated. Although not shown, the code reading section 452 includes a lighting system, an optical system and an image pickup section. As the code reading button 451 is operated, the code reading section 452 reads the coded image 2.

The key input section 453 is in fact a keyboard, although it may additionally include a pointing device such as a mouse.

The CPU 454 controls the entire access device 4. The ROM 455 and the HDD 456 are used to store the operation program of the CPU 454. The RAM 457 temporarily stores various data.

The display section 458 is used to output and display the second and third sets of information. The sound replay section 459 is used to output the second set of information by sound.

The communication control section 460 is used to access an information resource providing site 6 by way of a telecommunication network 5.

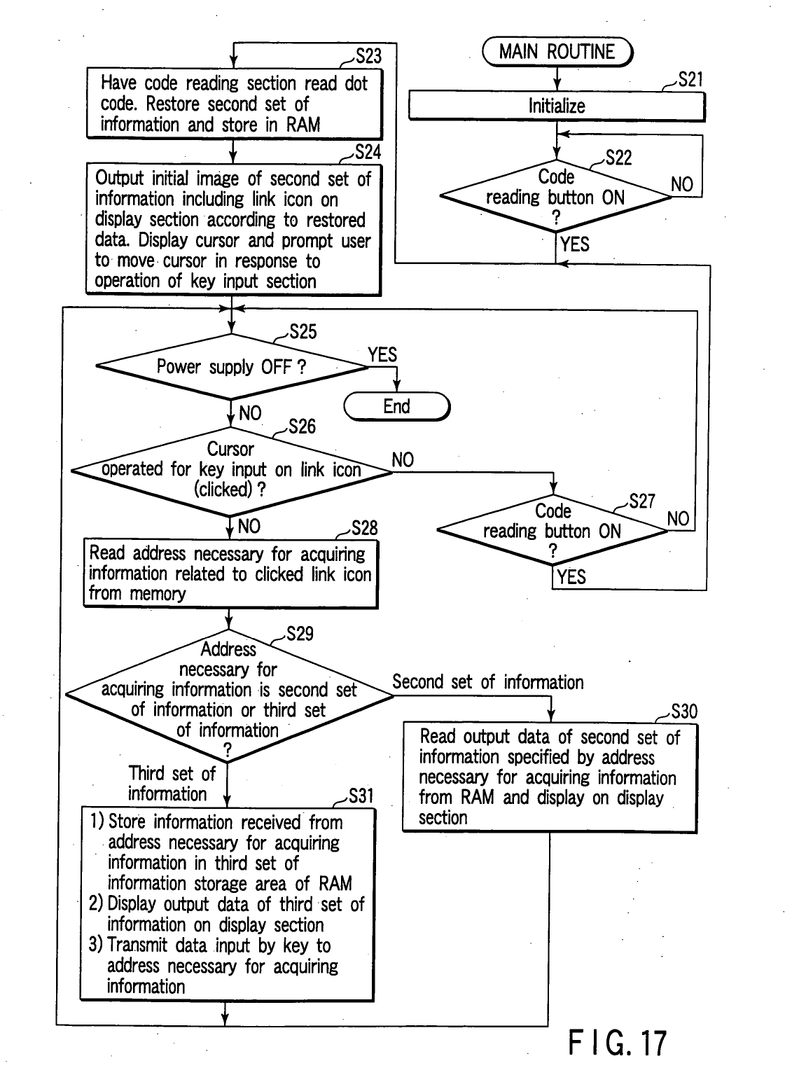

FIG. 17 is a main flowchart of the operation of the access device 4 of FIG. 16.

Firstly, as the power source is turned on, the initialization including the clear of the RAM 457 is performed (Step S21). Then, the access device 4 stays in a standby state until the code reading button 451 is turned on (Step S22).

As the code reading button 451 is turned on, the code reading section 452 reads the coded image 2 and restores the second set of information from the image data of the coded image 2, which second set of information is then stored in the RAM 457 (Step S23). The code reading button 451 is automatically turned off when the code image reading operation is terminated.

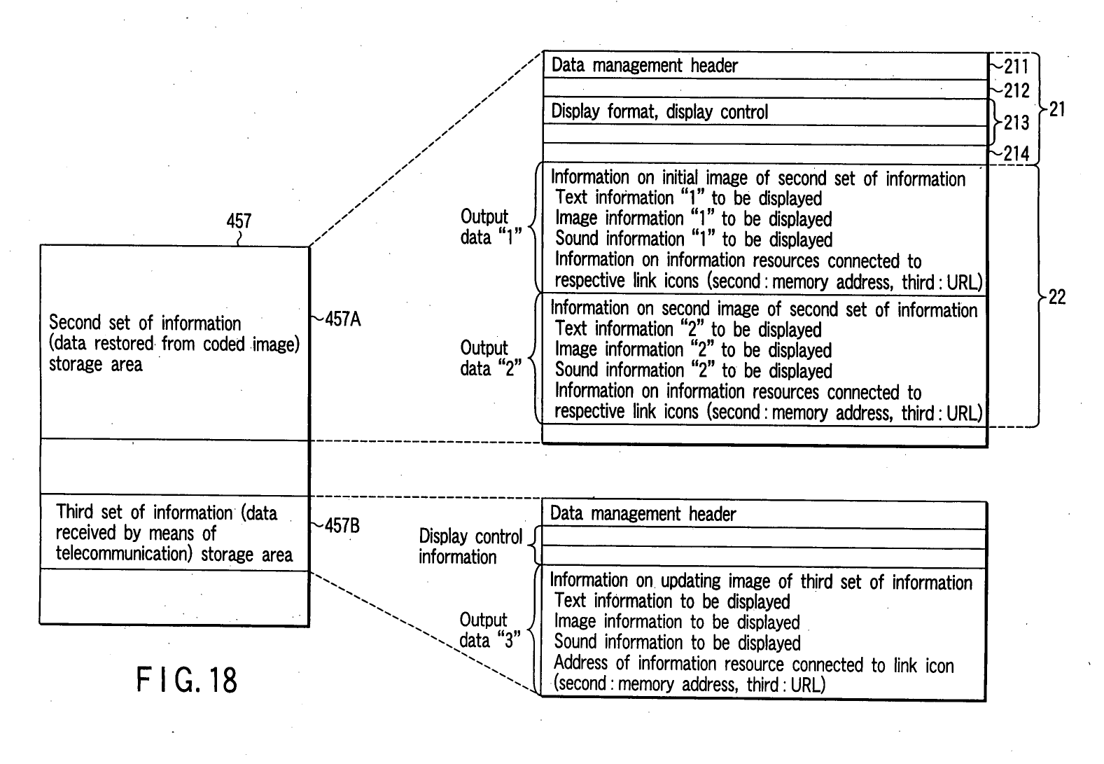

FIG. 18 is a memory map of the RAM 457 in FIG. 16. As shown in FIG. 18, the RAM 457 has a second set of information storage area 457A for storing the second set of information restored from the coded image 2 and a third set of information storage area 457B for storing the third set of information received from the information resource providing site 6.

The second set of information that is restored and stored in the second set of information storage area 457A for storing it contains control information 21 and output information 22 as described earlier by referring to the first embodiment. The control information 21 includes a data management header 211, a link icon output control data 212, an output control data 213 and a communication control data 214. The link icon output control data 212 is used to display link icons. The output information 22 includes a plurality of output data. The output data relate to respective images displaying the second set of information and include text information to be displayed on display section 458, image information also to be displayed on the display section 458, sound information to be replayed and output from sound replay section 459 and information on the information resources connected to the respective link icons.

The third set of information stored in the third set of information storage area 457B, which will be described hereinafter, includes a data management header and display control information as the control information and an output data as the output information.

The CPU 454 outputs an initial image data of the second set of in formation including those of link icons to the display section 458 on the basis of the data restored and stored in the second set of information storage area 457A of the RAM 457 and defines the cursor so as to be moved in response to the input operation conducted at the key input section 453 (Step S24). An initial image data as used herein refer to the data to be displayed first on the display section 458 when the second set of information is displayed in a plurality of images. Thus, an initial image of the second set of information is output to the display section 458 on the basis of the restored data. At this time, the CPU 454 displays link icons on the display section 458 according to the link icon output control data, or the output control information.

The link icons of this second embodiment may or may not be used as information necessary for inputting instructions for the operation of the access device 4. This will be described below.

Link icons to be used for obtaining information necessary for inputting instructions for the operation of the access device 4 includes a link icon that is displayed in the initial image of the second set of information and used for obtaining the third set of information.

Furthermore, a link icon A that is displayed in the initial image of the second set of information and used for obtaining the second image of the second set of information and a link icon B that is displayed in the second image of the second set of information obtained by the link icon A are existed. When the third set of information is obtained by the link icon B and displayed, the link icons A and B are used as information necessary for inputting instructions for the operation of the access device 4.

On the other hand, a link icon that is not used as information necessary for inputting instructions for the operation of the access device 4 includes a link icon C that is displayed in the initial image of the second set of information and used for obtaining the second image of the second set of information but not for obtaining the third set of information at all by means of the link icon C.

Any link icons that are not used for displaying the third set of information at all are link icons that are not used as information necessary for inputting instructions for the operation of the access device 4.

After displaying the initial image of the second set of information, the CPU 454 checks if the power source is turned off or not (Step S25) and terminates the processing operation if the power source is turned off.

If, on the other hand, the power source remains on, the CPU 454 checks if the cursor on the link icon in the image of the second set of information is key-inputted (is clicked) or not (Step S26). If the link icon is not clicked, it determines if the code reading button 451 is on or not (Step S27). The CPU 454 returns to Step S25 if it is found that the code reading button 451 is not on, whereas it returns to Step S23 to continue the operation of reading the coded image 2 if it is found that the code reading button 451 is held on.

If it is found that the link icon is clicked in Step S26, the CPU 454 reads out the address necessary for acquiring information relating to the clicked link icon from the second set of information storage area 457A of the RAM 457 (Step S28). Then, it determines if the readout address is the one for obtaining the second set of information or the one for obtaining the third set of information (Step S29). Note that the address necessary for acquiring information refers to the memory address of the second set of information storage area 457A in the memory map shown in FIG. 18 when the second set of information is to be acquired, whereas it refers to information to be used for selecting an information resource providing site including a URL when the third set of information is to be acquired.

If it is determined that the readout address necessary for acquiring information is the one for obtaining the second set of information, the CPU 454 reads out the second set of information from the second set of information storage area 457A in the RAM 457 specified the address necessary for acquiring information and displays it on the display section 458 (Step S30). If the read out information is sound information, it restores the original sound by means of the sound replay section 459 and outputs it. Thereafter, the CPU 454 returns to Step S25 and repeats the above processing sequence.

If, on the other hand, it is determined that the readout address necessary for acquiring information is the one for obtaining the third set of information, the CPU 454 receives the information from the address necessary for acquiring information by means of the communication control section 460 and stores it in the third set of information storage area 457B in the RAM 457. It may display the output data of the stored third set of information on the display section 458 and/or the sound reproduced by the sound replay section 459. It also transmits the data input by means of the key input section 453 to the address by means of the communication control section 460 (Step S31). Thereafter, the CPU 454 returns to Step S25 to repeat the above processing sequence.

FIG. 19 is a schematic illustration of a used car information magazine 1G that can be used for the second embodiment of printed matter/item 1.

Referring to FIG. 19, the used car information magazine 1G carries a photograph, the price, the model, the manufacturer, the color and the displacement of the engine of each of the used cars contained therein as visually readable images 7 (the first set of information) and coded images 2-1, 2-2, . . . containing the second set of information and printed near the respective visually readable images 7.

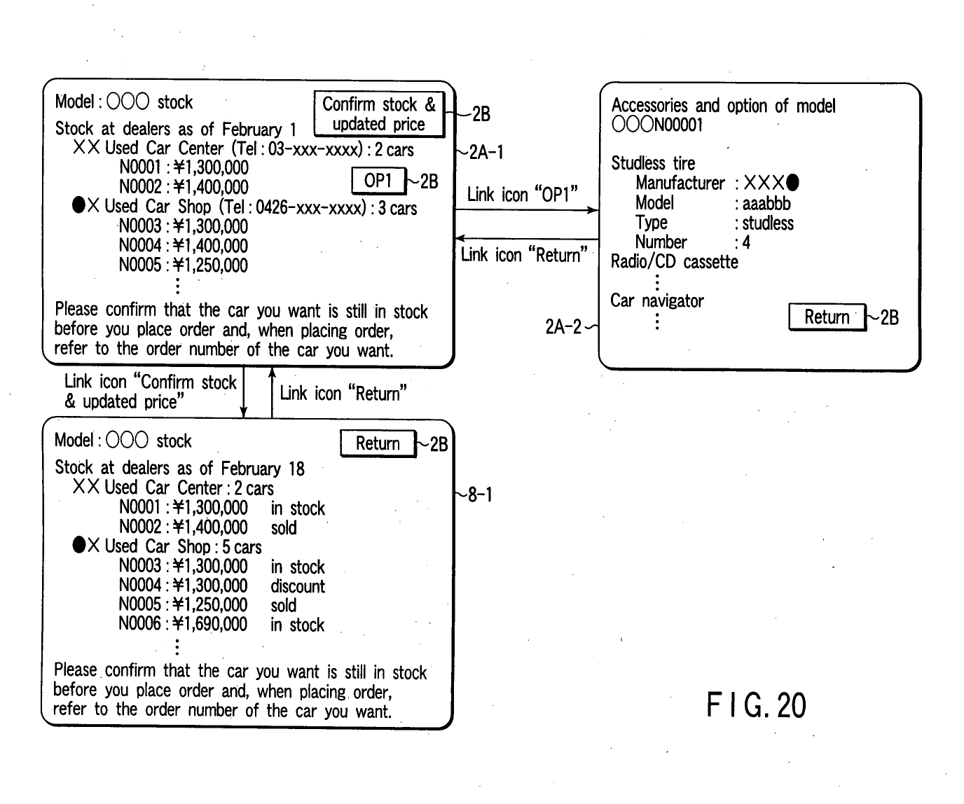

As one of the coded images 2-1, 2-2, . . . is read by the access device 4, an initial image 2A-1 of the second set of information as shown at upper left of FIG. 20 is displayed according to the data stored in the second set of information storage area 457A of the RAM 457. The initial image 2A-1 of the second set of information contains the stock of the model of the car and “stock confirmation & updated price” and “OP1” are displayed in it as link icons 2B.

When the link icon “OP1” is clicked, the second image 2A-2 of the second set of information as shown at upper right of FIG. 20 is displayed according to the data stored in the second set of information storage area 457A of the RAM 457. A link icon 2B of “return” is displayed in the second image 2A-2 of the second set of information. When the link icon “return” is clicked, the initial image 2A-1 of the second set of information is displayed back.

When the link icon “stock confirmation & updated price” is clicked in the initial image 2A-1 of the second set of information, the access device 4 receives the third set of information from the information resource providing site 6 as updating information according to the data stored in the second set of information storage area 457A of the RAM 457 and displays the first image 8-1 of the third set of information as shown at lower left in FIG. 20. Again, a link icon 2B of “return” is displayed in the first image 8-1 of the third set of information and, when the link icon “return” is clicked, the display returns to the initial image 2A-1 of the second set of information.

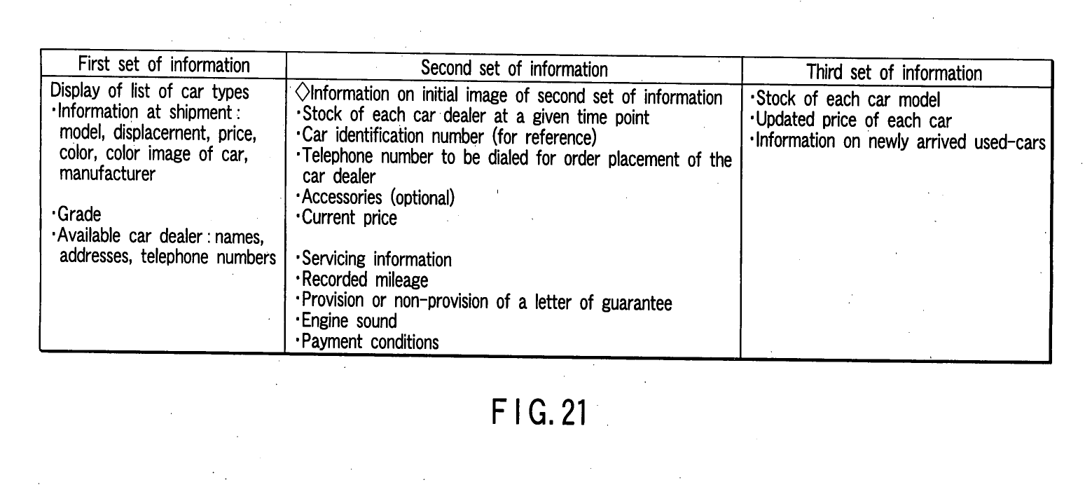

FIG. 21 is a list of pieces of information classified as the first through third sets of information that may be acquired from the printed matter/item 1 which is a used car information magazine 1G.

As shown in FIG. 21, the first set of information that is basic information may include a list of car types. The list includes the car model, the displacement, the price, the color, an image of the car, the manufacturer, etc of each car at a point of new car. The first set of information further includes the grade; available car dealer information such as the names, the addresses and the telephone numbers; etc.

The second set of information that is detailed information may include the stock of each car dealer at a given time point; the identification number of each car (for reference); the telephone number to be dialed for order placement of the car dealer; the equipment including accessories (optional); the current price; servicing information; the recorded mileage; provision or non-provision of a letter of guarantee; the engine sound; the payment conditions; etc.

The third set of information that is updating information may include the updated stock of each car model; the updated price of each car; information on newly arrived used cars; etc.

In this way, the second set of information is shown with a plurality of images.

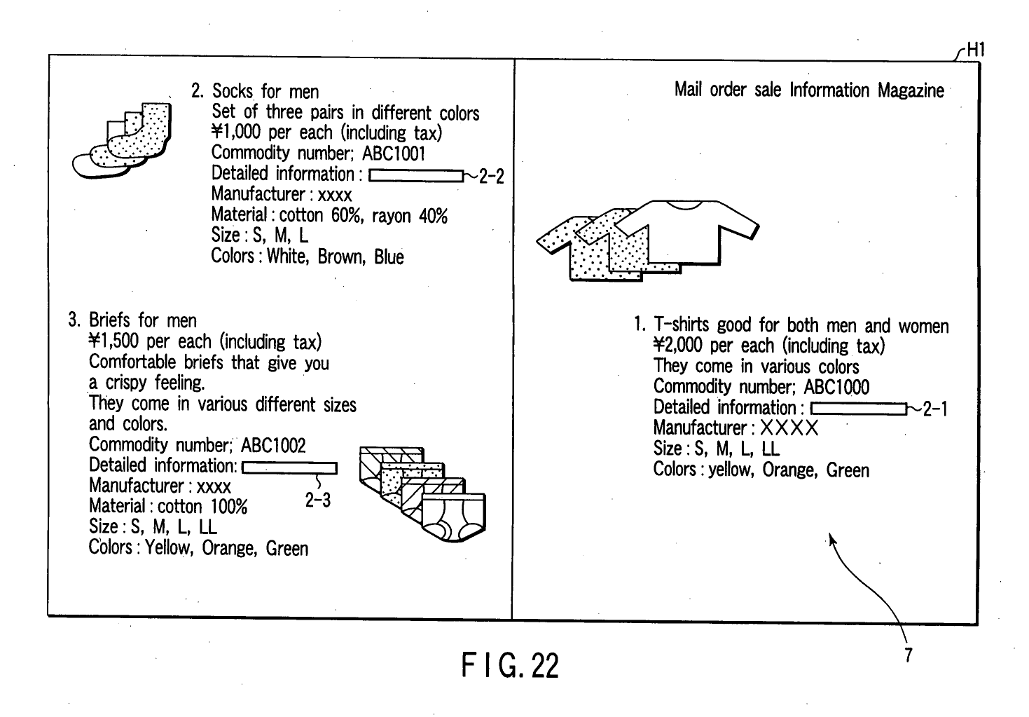

It is also possible to show the third set of information with a plurality of images. This will be described by referring to FIG. 22 illustrating a mail order sale catalog 1H that can be used for the printed matter/item 1.

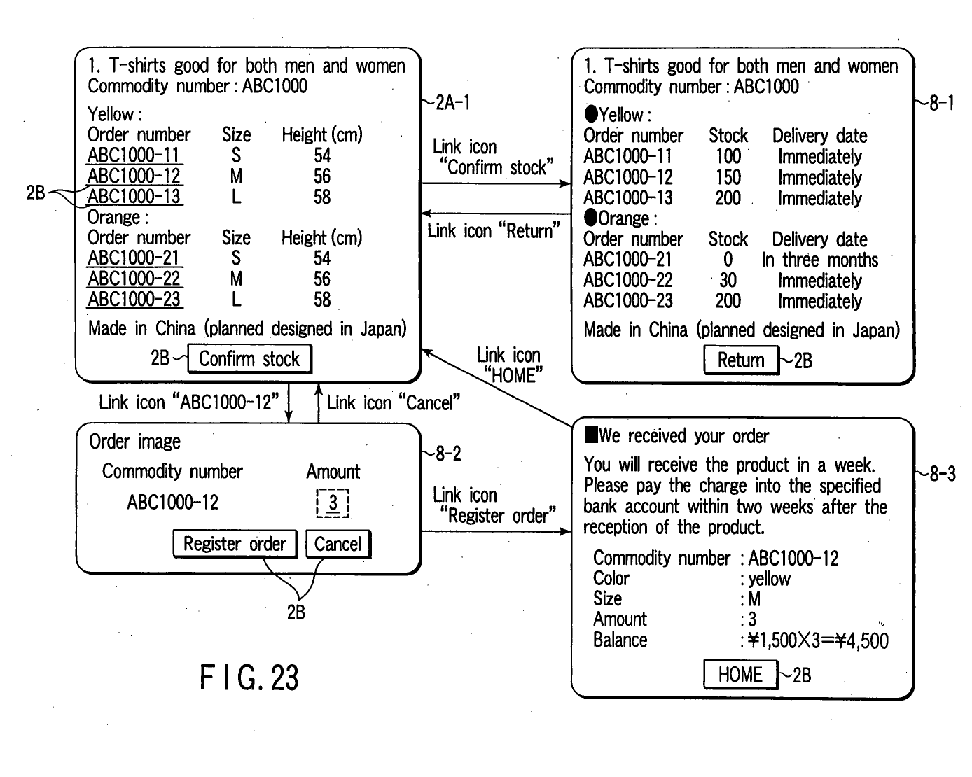

As shown in FIG. 22, the mail order sale catalog 1H contains a visually readable image 7 and coded images 2-1, 2-2, 2-3 of each item to be sold by a mail order. As a desired coded image (e. g., the coded image 2-1) is read by means of the access device 4, an initial image 2A-1 of the second set of information is displayed as shown at upper left in FIG. 23. As seen from FIG. 23, the initial image 2A-1 of the second set of information shows detailed information of the item along with link icons 2B including “confirm stock” and the order numbers (each underlined string of letters indicates that it operates as link icon).

When the link icon of “confirm stock” is clicked, the CPU 454 receives the third set of information as updating information from the information resource providing site 6 according to the data stored in the second set of information storage area 457A of the RAM 457 and displays the first image 8-1 of the third set of information as shown at upper right in FIG. 23. The first image 8-1 of the third set of information shows a link icon 2B of “return”. As the link icon “return” is clicked, the CPU 454 returns display to the initial image 2A-1 of the second set of information.

When any of the link icons 2B (e. g., “ABC1000-12”) displayed as order numbers in the initial image 2A-1 of the second set of information is clicked, the third set of information is received from the information resource providing site 6 according to the data stored in the second set of information storage area 457A of the RAM 457 and the second image 8-2 of the third set of information as shown at lower left in FIG. 23 is displayed. Link icons 2B of “register” and “cancel” are shown in the second image 8-2 of the third set of information. As the link icon of “cancel” is clicked, the CPU 454 returns display to the initial image 2A-1 of the second set of information. As a number is entered and then the link icon of “register order” is clicked, the item ID and the entered number are transmitted to the information resource providing site 6 according to the data stored in the second set of information storage area 457A of the RAM 457 and the third set of information is received from the information resource providing site 6 as updating information so that the third image 8-3 of the third set of information is displayed on the display in a manner as shown at lower right in FIG. 23. The third image 8-3 of the third set of information contains a link icon 2B of “HOME”. As the link icon of “HOME” is clicked, the CPU 454 returns display to the initial image 2A-1 of the second set of information.

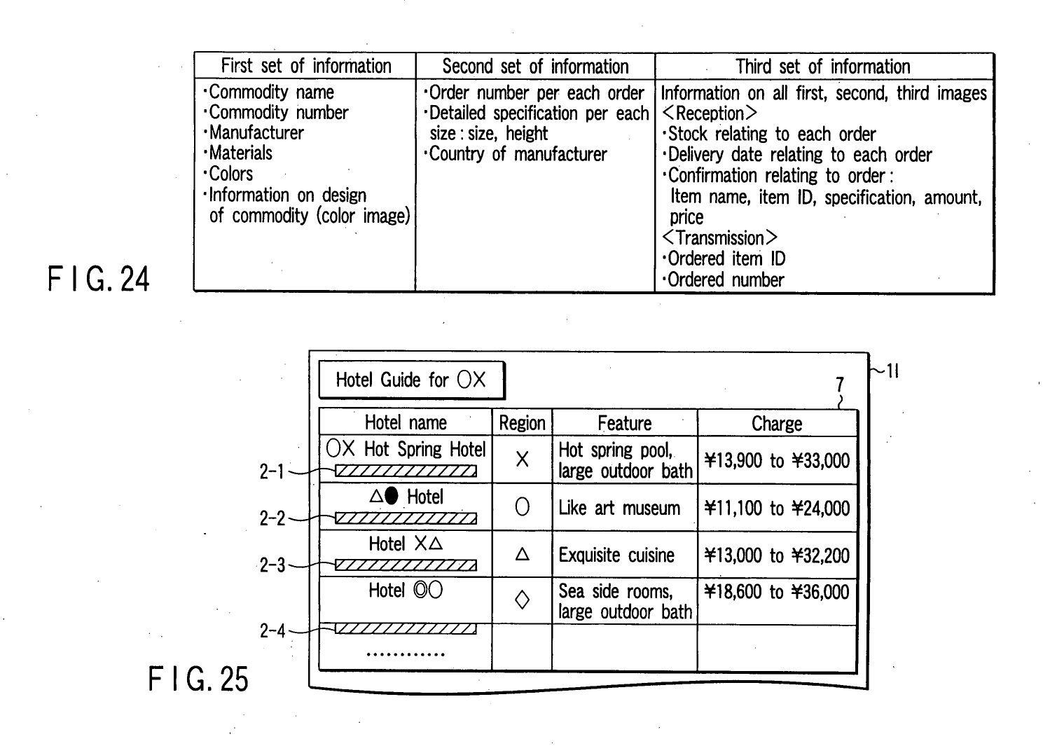

FIG. 24 is a list of pieces of information classified as the first through third sets of information that may be acquired from a mail order sale-catalog 1H to be used as the printed matter/item 1.

Referring to FIG. 24, the first set of information that is basic information may include the name; the item ID; the manufacturer; information on the materials used; the size category; the color; information on the design (a color image); etc. of each item.

The second set of information that is detailed information may include the order number of each order unit; the detailed specification of each size category; the size and the height; the country of manufacturer; etc.

The third set of information that is updating information may include information on the stock per order unit; delivery related information per unit order; confirmation of the order such as the item name, the item ID, the specification, the amount and the price; etc. of each item. The third set of information to be transmitted to the information resource providing site 6 may include the ordered item ID; the ordered number; etc.

Thus, the third set of information may be displayed in a plurality of images.

Both the second and third sets of information may be displayed in a plurality of images. This will be described by referring to FIG. 25 that schematically illustrates a hotel guide magazine 1I that can be used as the printed matter/item 1.

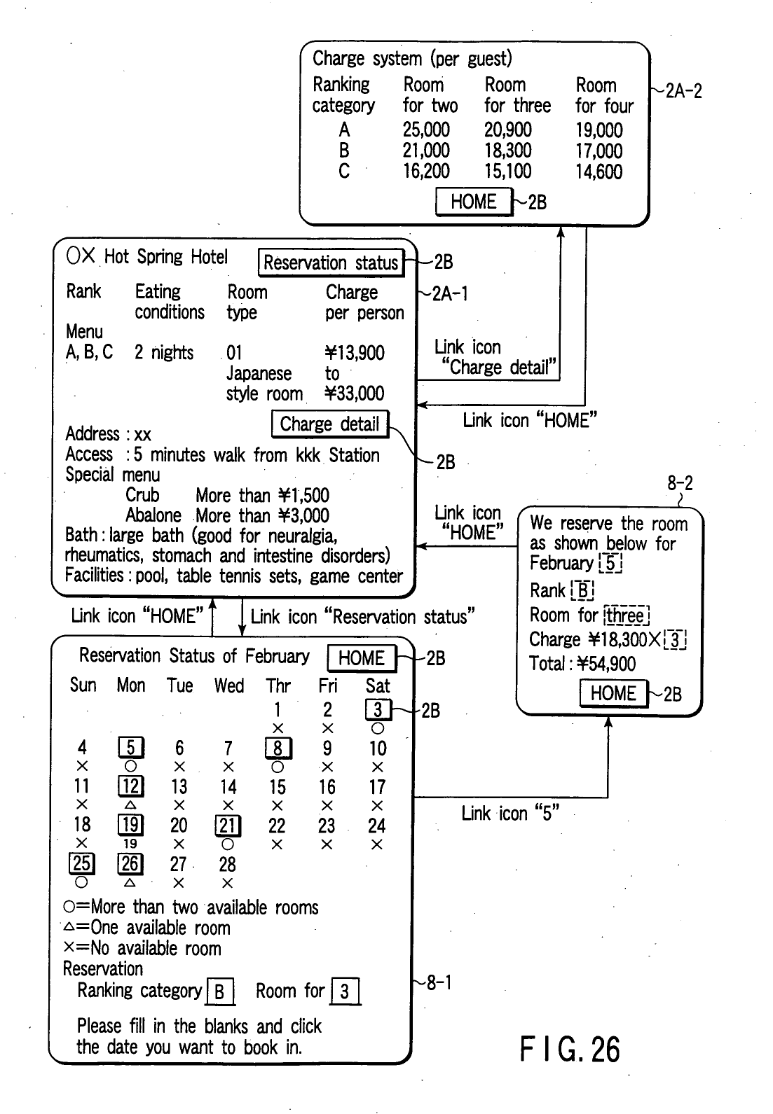

As shown in FIG. 25, a visually readable image 7 and coded images 2-1, 2-2, 2-3, 2-4 are printed for each accommodation in the hotel guide magazine 1I. As a desired coded image (e. g., 2-1) is read by the access device 4, an initial image 2A-1 of the second set of information as shown at upper left in FIG. 26 is displayed. Detailed information on the accommodation and link icons 2B of “charge detail” and “reservation status” are shown in the initial image 2A-1 of the second set of information.

When the link icon of “charge detail” is clicked, the second image 2A-2 of the second set of information is displayed according to the data stored in the second set of information storage area 457A of the RAM 457 in a manner as shown at upper right in FIG. 25. The second image 2A-2 of the second set of information contains a link icon 2B of “HOME”. As the link icon of “HOME” is clicked, the CPU 454 returns display to the initial image 2A-1 of the second set of information.

When the link icon of “reservation status” is clicked in the initial image 2A-1 of the second set of information, the third set of information is received as updating information from the information resource providing site 6 according to the data stored in the second set of information storage area 457A of the RAM 457 and the first image 8-1 of the third set of information is displayed in a manner as shown at lower left in FIG. 25. The first image 8-1 of the third set of information contains a link icon 2B of “HOME” and the dates where rooms are available. As the link icon of “HOME” is clicked, the CPU 454 returns display to the initial image 2A-1 of the second set of information. When the rank of the room and the number of people expected to stay in the room are entered and subsequently the link icon of the calendar day (“e. g., “5”) of the expected stay is clicked, these pieces of information are transmitted to the information resource providing site 6 according to the data stored in the second set of information storage area 457A of the RAM 457 and the third set of information is received as updating information from the information resource providing site 6 so that the second image 8-2 of the third set of information as shown at lower right in FIG. 26 is displayed. The second image 8-2 of the third set of information contains a link icon 2B of “HOME”. As the link icon of “HOME” is clicked, the CPU 454 returns display to the initial image 2A-1 of the second set of information.

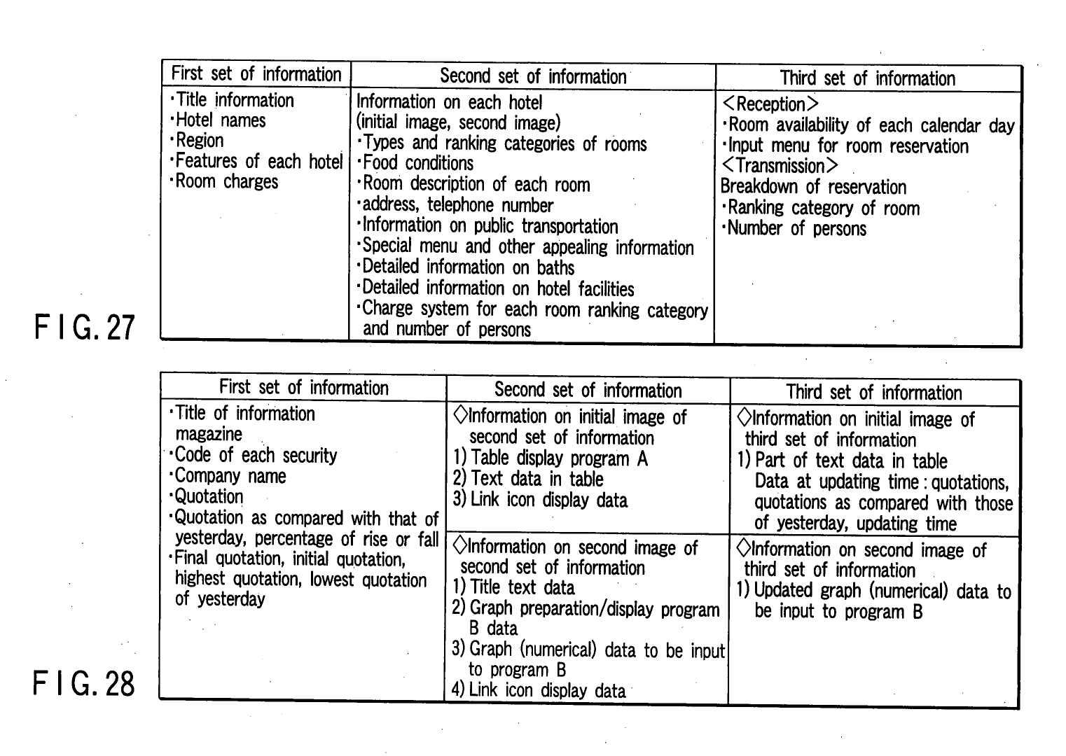

FIG. 27 is a list of pieces of information classified as the first through third sets of information that may be acquired from a hotel guide magazine 1I to be used as the printed matter/item 1.

Referring to FIG. 27, the first set of information that is basic information may include title information; the hotel names; the region; features of each hotel; room charges; etc.

The second set of information that is detailed information may include the types and ranking categories of rooms; the food conditions; the room description of each room; the address and the telephone number; information on public transportation; the special menu and other appealing information; detailed information on baths; detailed information on the facilities of the hotel; the charge system for each room ranking category and number of persons; etc.

The third set of information that is updating information may include room availability of each calendar day; input menu for room reservation; etc. The third set of information to be transmitted to the information resource providing site 6 may include the rank of the room that the customer wants to reserve; the number of persons expected to stay; etc.

Thus, both the second and third sets of information may be displayed in a plurality of images.

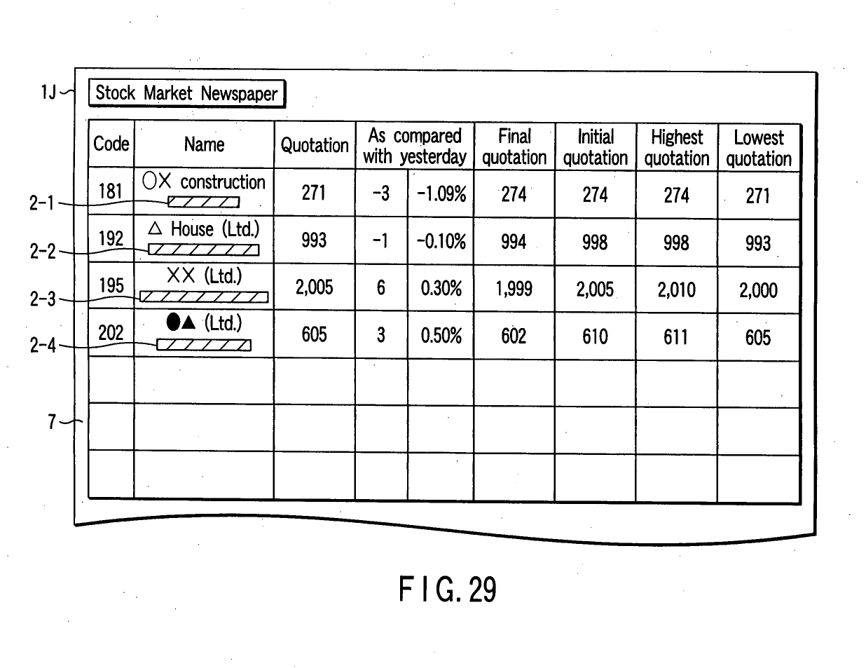

It is also possible to acquire the third set of information by way of a plurality of images of the second set of information. This will be described by referring to FIGS. 28 through 30. FIG. 28 is a list of pieces of information classified as the first through third sets of information that may be acquired from an information magazine (a stock market newspaper 1J) to be used as printed matter/item 1 as shown in FIG. 29.

Referring to FIGS. 28 and 29, the stock market newspaper 1J contains the first set of information (visually readable image 7) that is basic information that may include the title of the information magazine; the codes allocated to the securities; the names of enterprises; the market quotations; the rise or fall of each market quotation as expressed in terms of percentage and quotation as compared with that of yesterday; the final quotation, the initial quotation, the highest quotation and the lowest quotations of yesterday of each security; etc. Coded images 2-1, 2-2, 2-3, 2-4 are printed near the name of each of the enterprises.

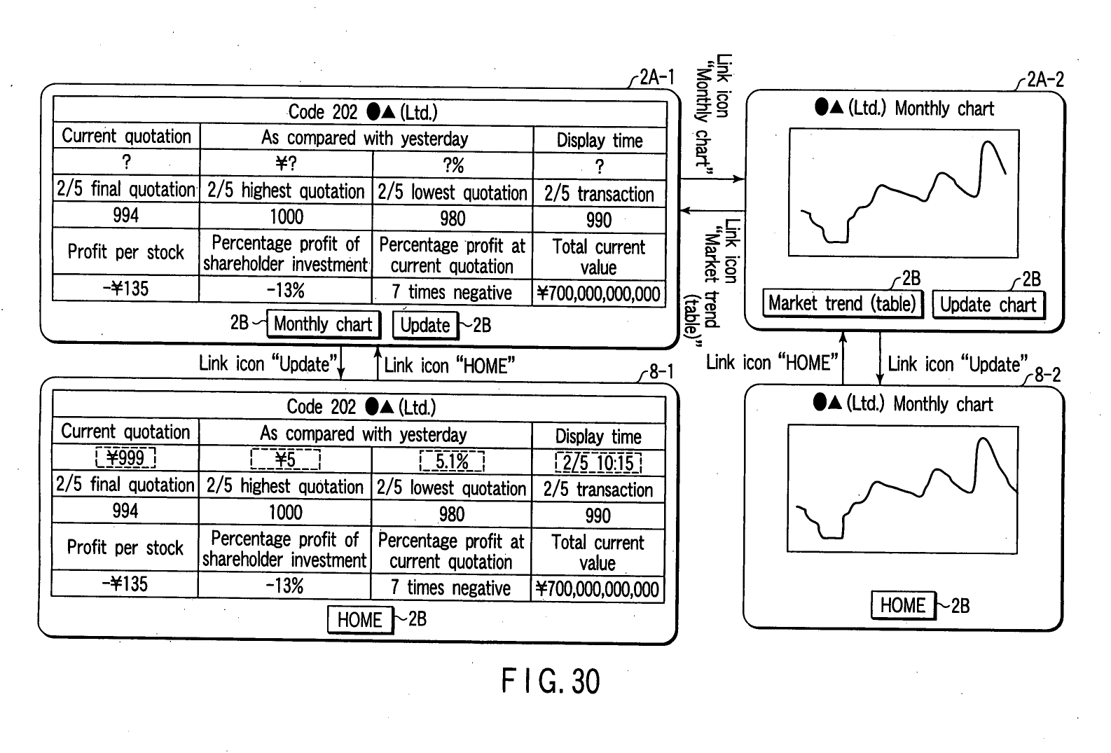

When a selected coded image (e. g., 2-4) is read by means of the access device 4, an initial image 2A-1 of the second set of information is displayed in a manner as shown at upper left in FIG. 30. In the initial image 2A-1 of the second set of information, detailed information on the stocks of the selected enterprise is shown in the form of a table and also link icons 2B of “monthly chart” and “update” are displayed. It will be appreciated that each of the coded images 2 contains a table display program A, text data of the table and link icon display data as information relating to the initial image of the second set of information.

As the link icon “update” shown in the initial image 2A-1 of the second set of information is clicked, the third set of information is received as updating information from the information resource providing site 6 according to the data stored in the second set of information storage area 457A of the RAM 457 and the first image 8-1 of the third set of information as shown at lower left in FIG. 30 is displayed. The first image 8-1 of the third set of information contains a link icon 2B of “HOME”. As the link icon of “HOME” is clicked, the CPU 454 returns display to the initial image 2A-1 of the second set of information. For the above display, the third set of information contains part of the text data in the table and data at updating (the market quotations, the rise or fall of each market quotation as compared with yesterday as expressed in terms of a percentage, the updating time).

When the link icon of “monthly chart” is clicked in the initial image 2A-1 of the second set of information, the second image 2A-2 of the second set of information as shown at upper left in FIG. 30 is displayed according to the data stored in the second set of information storage area 457A of the RAM 457. The second image 2A-2 of the second set of information contains link icons 2B of “market trend (table)” and “chart updating”. It will be appreciated that each of the coded images 2 contains title text data, graph preparation/display program B data, graph (numerical) data to be input to the program B, link icon display data, etc. as information relating to the second image of the second set of information. In other words, a graph is output to the display section 458 by using the program B data and the graph (numerical) data to be input to the program B data in the above Step S31.

As the link icon of “market trend (table)” is clicked in the second image 2A-2 of the second set of information the CPU 454 returns display to the initial image 2A-1 of the second set of information.

As the link icon of “chart updating” is clicked in the second image 2A-2 of the second set of information, the third set of information is received as updating information from the information resource providing site 6 according to the data stored in the second set of information storage area 457A of the RAM 457 and the second image 8-2 of the third set of information as shown at lower right in FIG. 30 is displayed. The second image 8-2 of the third set of information contains a link icon 2B of “HOME”. As the link icon of “HOME” is clicked, the CPU 454 returns display to the second image 2A-2 of the second set of information. For the above display, the third set of information contains the updated values of the graph (numerical) data to be input to the program B.

Thus, as for the information relating to the second image 8-2 of the third set of information, the program B read out from the second set of information is executed to obtain only graph (numerical) data to be input to the program B as the third set of information by way of the communication control section 460 so as to display additional graphs without the need of inputting any program. This arrangement is effective for reducing the amount of data to be transmitted.

While the present invention is described by way of embodiments and examples, the present invention is by no means limited thereto. It will be appreciated that the embodiments and the examples described above may be modified appropriately without departing from the scope of the present invention.

Thus, the present invention is defined as follows.

(1) A printed matter comprising:

a first set of information containing at least one of characters, signs, graphics, painted pictures, photographic pictures and computer graphic printed in a form of visually readable; and

a second set of information obtained by coding data and printed in a form of a coded image optically readable to a reading device, the second set of information being different from the first set of information, wherein

the coded image further including:

output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of operation of the reading device of optically reading out the coded image, restoring the second set of information from the read out coded image and making the output unit of the access device adapted to access the external information resource by way of a telecommunication network output the restored second set of information in a perceivable form.

Thus, a person who wants to retrieve and acquire the information in which he or she is interested can detect it easily in a short period of time by acquiring the first set of information arranged on a printed matter that the person can easily grasp at a glance. Thus, the person can roughly detect the information by way of the visually readable image. Then, since the coded image is provided around the first set of information and contains detailed information related to the detected first set of information, it is now possible to obtain detailed secondary information as a normal step of information acquisition. It will be appreciated that the obtained secondary information reflects the person's intention of selectively acquiring information on the basis of the primary information that belongs to that person. In other words, any situations where a large amount of unnecessary readable information is randomly provided to the person can be effectively avoided. Particularly, the space for accommodating information on the printed matter can be reduced to save the precious natural resource, of paper as the coded image is provided on the printed matter. Additionally, because the coded image contains output control information to be used to make the output unit output information necessary for inputting instructions for driving the access device to obtain updated information, or the, third set of information, by way of a telecommunication network on an on line basis in addition to the second set of information, the person who wants to acquire information can selectively use a means for acquiring most updated information to offset the weak point of a paper medium. Therefore, the present invention can provide a medium of selectively acquiring the information in stages that the user wants by means of an optimal combination of the advantages of a paper medium and those of an on-line telecommunication means. Additionally, the present invention can provide a medium for enabling to optimally exploit the advantage of the paper medium of allowing the user to acquire the information he or she wants at glance, that of a code of providing detailed information if necessary and that of a telecommunication network of providing information on an on line basis.

(2) The printed matter according to (1), wherein,

when the output unit is an image display unit, the information for inputting instructions necessary for the operation is provided in the form of an image through which instructions necessary for causing the access device to perform the sequence of operation are input.

With this arrangement, since the information for inputting instructions necessary for the operation is provided in the form of an image, the user can visually perceive it with ease. In other words, it is provided in the form of an interface that can be handled with ease.

(3) The printed matter according to (2), wherein

the information for inputting instructions necessary for the operation provided in the form of the image is a link icon.

With this arrangement, since the image for inputting instructions necessary for the operation is a link icon, the user can easily recognize the object through which the instructions are input and its function. Therefore, the user can smoothly operate the means for inputting instructions necessary for the operation.

(4) The printed matter according to (1), wherein,

when the output unit is a sound output unit, the information for inputting instructions necessary for the operation is provided in the form of sound with which instructions necessary for causing the access device to perform the sequence of operation are input.

With this arrangement, since the information for inputting instructions necessary for the operation is provided in the form of sound, the user can perceive it with ease if he or she is visually handicapped. In other words, it is provided in the form of an interface that can be handled with ease.

(5) The printed matter according to any of (1) through (4), wherein

the first set of information is basic information and the second set of information is detailed information relating to the basic information, while the third set of information is updating information relating to the basic information.

With this arrangement, the basic information can be detected quickly and the user can selectively acquire detailed information on the basis of the detected basic information and also updating information on an on line basis. In other words, the user can utilize a system that compensates the disadvantage of paper medium of being unable of immediately delivering updated information and can acquire updated information on an on line basis.

(6) An information acquiring method comprising:

reading a coded image from a printed matter by a reading device and restoring a second set of information and output control information from the coded image read by the reading device, the printed matter comprising a first set of information containing at least one of characters, signs, graphics, painted pictures, photographic pictures and computer graphic printed in a form of visually readable and the second set of information obtained by coding data and printed in a form of the coded image optically readable to the reading device, the second set of information being different from the first set of information, the coded image further including the output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of the operation of the reading device of optically reading out the coded image, restoring the second set of information from the read out coded image and making the output unit of the access device adapted to access the external information resource by way of a telecommunication network output the restored second set of information in a perceivable form; and

outputting the restored second set of information in a form perceivable from the output unit and also the information for inputting instructions necessary for the above operation on the basis of the restored output control information from the output unit.

Thus, a person who wants to retrieve and acquire the information in which he or she is interested can detect it easily in a short period of time by acquiring the first set of information arranged on a printed matter that the person can easily grasp at a glance. Thus, the person can roughly detect the information by way of the visually readable image. Then, since the coded image is provided around the first set of information and contains detailed information related to the detected first set of information, it is now possible to obtain detailed secondary information as a normal step of information acquisition. It will be appreciated that the obtained secondary information reflects the person's intention of selectively acquiring information on the basis of the primary information that belongs to that person. In other words, any situations where a large amount of unnecessary readable information is randomly provided to the person can be effectively avoided. Particularly, the space for accommodating information on the printed matter can be reduced to save the precious natural resource of paper as the coded image is provided on the printed matter. Additionally, because the coded image contains output control information to be used to make the output unit output information necessary for inputting instructions for driving the access device to obtain updated information, or the third set of information, by way of a telecommunication-network on an on line basis in addition to the second set of information, the person who wants to acquire information can selectively use a means for acquiring most updated information to offset the weak point of a paper medium. Therefore, the present invention can provide a method of selectively acquiring the information in stages that the user wants by means of an optimal combination of the advantages of a paper medium and those of an on-line telecommunication means. Additionally, the present invention can provide a method for enabling to optimally exploit the advantage of the paper medium of allowing the user to acquire the information he or she wants at glance, that of a code of providing detailed information if necessary and that of a telecommunication network of providing information on an on line basis.

(7) The method according to (6), wherein,

when the output unit is an image display unit, the information for inputting instructions necessary for the operation is provided in the form of an image through which instructions necessary for causing the access device to perform the sequence of operation are input.

With this arrangement, since the information for inputting instructions necessary for the operation is provided in the form of an image, the user can visually perceive it with ease. In other words, there is provided an information acquiring method with an interface that can be handled with ease.

(8) The method according to (7), wherein

the information for inputting instructions necessary for the operation provided un the form of the image is a link icon.

With this arrangement, since the image for inputting instructions necessary for the operation is a link icon, the user can easily recognize the object through which the instructions are input and its function. Therefore, there is provided an information acquiring method with which the user can smoothly operate the means for inputting instructions necessary for the operation.

(9) The method according to (6), wherein,

when the output unit is a sound output unit, the information for inputting instructions necessary for the operation is provided in the form of sound with which instructions necessary for causing the access device to perform the sequence of operation are input.

With this arrangement, since the information for inputting instructions necessary for the operation is provided in the form of sound, the user can perceive it with ease if he or she is visually handicapped. In other words, there is provided an information acquiring method with an interface that can be handled with ease.

(10) The method according to any of (6) through (9), wherein

the first set of information is basic information and the second set of information is detailed information relating to the basic information, while the third set of information is updating information relating to the basic information.

With this arrangement, the basic information can be detected quickly and the user can selectively acquire detailed information on the basis of the detected basic information and also updating information on an on line basis. In other words, there is provided an information acquiring method with which the user can utilize a system that compensates the disadvantage of paper medium of being unable of immediately delivering updated information and can acquire updated information on an on line basis.

(11) An information acquiring system comprising:

a reading device for optically reading a coded image from a printed matter comprising a first set of information containing at least one of characters, signs, graphics, painted pictures, photographic pictures and computer graphic printed in a form of visually readable and a second set of information obtained by coding data and printed in a form of the coded image optically readable to the reading device, the second set of information being different from the first set of information, wherein the coded image further including output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of the operation of the reading device of optically reading out the coded image, restoring the second set of information from the read out coded image and making the output unit of the access device adapted to access the external information resource by way of a telecommunication network output the restored second set of information in a perceivable form;

a restoring unit for restoring the second set of information and the output control information from the coded image read by the reading device; and

a control unit for outputting the restored second set of information in a form perceivable from the output unit and also the information for inputting instructions necessary for the above operation on the basis of the restored output control information from the output unit.

Thus, a person who wants to retrieve and acquire the information in which he or she is interested can detect it easily in a short period of time by acquiring the first set of information arranged on a printed matter that the person can easily grasp at a glance. Thus, the person can roughly detect the information by way of the visually readable image. Then, since the coded image is provided around the first set of information and contains detailed information related to the detected first set of information, it is now possible to obtain detailed secondary information as a normal step of information acquisition. It will be appreciated that the obtained secondary information reflects the person's intention of selectively acquiring information on the basis of the primary information that belongs to that person. In other words, any situations where a large amount of unnecessary readable information is randomly provided to the person can be effectively avoided. Particularly, the space for accommodating information on the printed matter can be reduced to save the precious natural resource of paper as the coded image is provided on the printed matter. Additionally, because the coded image contains output control information to be used to make the output unit output information necessary for inputting instructions for driving the access device to obtain updated information, or the third set of information, by way of a telecommunication network on an on line basis in addition to the second set of information, the person who wants to acquire information can selectively use a means for acquiring most updated information to offset the weak point of a paper medium. Therefore, the present invention can provide a system of selectively acquiring the information in stages that the user wants by means of an optimal combination of the advantages of a paper medium and those of an on-line telecommunication means. Additionally, the present invention can provide a system for enabling to optimally exploit the advantage of the paper medium of allowing the user to acquire the information he or she wants at glance, that of a code of providing detailed information if necessary and that of a telecommunication network of providing information on an on line basis.

(12) The system according to (11), wherein,

when the output unit is an image display unit, the information for inputting instructions necessary for the operation is provided in the form of an image through which instructions necessary for causing the access device to perform the sequence of operation are input.

With this arrangement, since the information for inputting instructions necessary for the operation is provided in the form of an image, the user can visually perceive it with ease. In other words, there is provided an information acquiring system with an interface that can be handled with ease.

(13) The system according to (12), wherein

the information for inputting instructions necessary for the operation provided un the form of the image is a link icon.

With this arrangement, since the image for inputting instructions necessary for the operation is a link icon, the user can easily recognize the object through which the instructions are input and its function. Therefore, there is provided an information acquiring system with which the user can smoothly operate the means for inputting instructions necessary for the operation.

(14) The system according to (11), wherein,

when the output unit is a sound output unit, the information for inputting instructions necessary for the operation is provided in the form of sound with which instructions necessary for causing the access device to perform the sequence of operation are input.

With this arrangement, since the information for inputting instructions necessary for the operation is provided in the form of sound, the user can perceive it with ease if he or she is visually handicapped. In other words, there is provided an information acquiring system with an interface that can be handled with ease.

(15) The system according to any of (11) through (14), wherein

the first set of information is basic information and the second set of information is detailed information relating to the basic information, while the third set of information is updating information relating to the basic information.

With this arrangement, the basic information can be detected quickly and the user can selectively acquire detailed information on the basis of the detected basic information and also updating information on an on line basis. In other words, there is provided an information acquiring system with which the user can utilize a system that compensates the disadvantage of paper medium of being unable of immediately delivering updated information and can acquire updated information on an on line basis.

(16) An information resource to be used with a printed matter comprising a first set of information containing at least one of characters, signs, graphics, painted pictures, photographic pictures and computer graphic printed in a form of visually readable and a second set of information obtained by coding data and printed in a form of a coded image optically readable to a reading device, the second set of information being different from the first set of information, wherein the coded image further including output control information for making an output unit of an access device output information for necessary inputting instructions for causing the access device to perform a sequence of operation of accessing the information resource, obtaining a third set of information different from the first and second sets of information from the information resource and making the output unit output the obtained third set of information in a perceivable form at the time of the operation of the reading device of optically reading out the coded image, restoring the second set of information from the read out coded image and making the output unit of the access device adapted to access the information resource by way of a telecommunication network output the restored second set of information in a perceivable form, the second set of information and the output control information being restored as a result of reading the coded image;

the restored second set of information being output in a form perceivable from the output unit, the information for inputting instructions necessary for the operation being output by the output unit according to the restored output control information; and

the information resource being accessed by the access device by way of a telecommunication network by utilizing the information for inputting instructions necessary for the operation output by the output unit,

the information resource comprising:

a communication unit for communicating with the access device by way of the telecommunication network; and

a memory unit for storing the third set of information corresponding to the information for inputting instructions necessary for the operation.

Thus, a person who wants to retrieve and acquire the information in which he or she is interested can detect it easily in a short period of time by acquiring the first set of information arranged on a printed matter that the person can easily grasp at a glance. Thus, the person can roughly detect the information by way of the visually readable image. Then, since the coded image is provided around the first set of information and contains detailed information related to the detected first set of information, it is now possible to obtain detailed secondary information as a normal step of information acquisition. It will be appreciated that the obtained secondary information reflects the person's intention of selectively acquiring information on the basis of the primary information that belongs to that person. In other words, any situations where a large amount of unnecessary readable information is randomly provided to the person can be effectively avoided. Particularly, the space for accommodating information on the printed matter can be reduced to save the precious natural resource of paper as the coded image is provided on the printed matter. Additionally, because the coded image contains output control information to be used to make the output unit output information necessary for inputting instructions for driving the access device to obtain updated information, or the third set of information, by way of a telecommunication network on an on line basis in addition to the second set of information, the person who wants to acquire information can selectively use a means for acquiring most updated information to offset the weak point of a paper medium. With this arrangement, since the third set of information corresponding to the information for inputting instructions necessary for the operation is stored and controlled as a predetermined information resource by the memory unit, the user can utilize the third set of information as updating information whenever necessary and the information resource provider can centrally control the operation of updating and modifying the information, providing the information with additional information and so on. Therefore, the present invention can provide an environment with which the user can quickly and fully exploits the advantages of the third set of information in an easy way.

(17) A program for causing a computer to realize:

a function of reading a coded image from a printed matter by a reading device and restoring a second set of information and output control information from the coded image read by the reading device, the printed matter comprising a first set of information containing at least one of characters, signs, graphics, painted pictures, photographic pictures and computer graphic printed in a form of visually readable and the second set of information obtained by coding data and printed in a form of the coded image optically readable to the reading device, the second set of information being different from the first set of information, the coded image further including the output control information for making an output unit of an access device output information for necessary inputting instructions for causing the access device to perform a sequence of operation of accessing an external information resource, obtaining a third set of information different from the first and second sets of information from the information resource and making the output unit output the obtained third set of information in a perceivable form at the time of the operation of the reading device of optically reading out the coded image, restoring the second set of information from the read out coded image and making the output unit of the access device adapted to access the external information resource by way of a telecommunication network output the restored second set of information in a perceivable form; and

a function of outputting the restored second set of information in a form perceivable from the output unit and also the information for inputting instructions necessary for the above operation on the basis of the restored output control information from the output unit.

Thus, a person who wants to retrieve and acquire the information in which he or she is interested can detect it easily in a short period of time by acquiring the first set of information arranged on a printed matter that the person can easily grasp at a glance. Thus, the person can roughly detect the information by way of the visually readable image. Then, since the coded image is provided around the first set of information and contains detailed information related to the detected first set of information, it is now possible to obtain detailed secondary information as a normal step of information acquisition. It will be appreciated that the obtained secondary information reflects the person's intention of selectively acquiring information on the basis of the primary information that belongs to that person. In other words, any situations where a large amount of unnecessary readable information is randomly provided to the person can be effectively avoided. Particularly, the space for accommodating information on the printed matter can be reduced to save the precious natural resource of paper as the coded image is provided on the printed matter. Additionally, because the coded image contains output control information to be used to make the output unit output information necessary for inputting instructions for driving the access device to obtain updated information, or the third set of information, by way of a telecommunication network on an on line basis in addition to the second set of information, the person who wants to acquire information can selectively use a means for acquiring most updated information to offset the weak point of a paper medium. Thus, according to the invention, it is possible to easily provide a feasible scheme at a reasonable cost by causing a computer to perform an information acquiring operation according to the invention. Such a scheme can adapt itself to additional functions and modifications to the functions.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A printed matter comprising:
a first set of information containing at least one of characters, signs, graphics, painted pictures, photographic pictures and computer graphic printed in a form of visually readable; and
a second set of information obtained by coding data and printed in a form of a coded image optically readable to a reading device, said second set of information being different from said first set of information, wherein:
said coded image further includes:
output control information for making an output unit of an access device output information for necessary inputting of instructions for causing said access device to perform a sequence of operations of accessing an external information resource, obtaining a third set of information different from said first and second sets of information from the information resource and making said output unit output said obtained third set of information in a perceivable form at the time of operation of said reading device optically reading out said coded image, restoring said second set of information from the read out coded image and making said output unit of said access device adapted to access the external information resource by way of a telecommunication network to output said restored second set of information in a perceivable form.

2. The printed matter according to claim 1, wherein, when said output unit comprises an image display unit, said information for inputting instructions necessary for the operations is provided in the form of an image through which instructions necessary for causing said access device to perform said sequence of operations are input.

3. The printed matter according to claim 2, wherein said information for inputting instructions necessary for the operation provided in the form of the image comprises a link icon.

4. The printed matter according to claim 1, wherein, when said output unit comprises a sound output unit, said information for inputting instructions necessary for the operations is provided in the form of sound with which instructions necessary for causing said access device to perform said sequence of operations are input.

5. The printed matter according to claim 1, wherein said first set of information is basic information and said second set of information is detailed information relating to said basic information, while said third set of information is updating information relating to said basic information.

6. An information acquiring method comprising:
reading a coded image from a printed matter by a reading device and restoring a second set of information and output control information from said coded image read by said reading device, said printed matter comprising a first set of information containing at least one of characters, signs, graphics, painted pictures, photographic pictures and computer graphic printed in a form of visually readable and said second set of information obtained by coding data and printed in a form of said coded image optically readable to said reading device, said second set of information being different from said first set of information, said coded image further including said output control information for making an output unit of an access device output information for necessary inputting of instructions for causing said access device to perform a sequence of operations of accessing an external information resource, obtaining a third set of information different from said first and second sets of information from the information resource and making said output unit output said obtained third set of information in a perceivable form at the time of the operation of said reading device optically reading out said coded image, restoring said second set of information from the read out coded image and making said output unit of said access device adapted to access the external information resource by way of a telecommunication network to output said restored second set of information in a perceivable form; and
outputting said restored second set of information in a form perceivable from said output unit and also said information for inputting instructions necessary for the above operations on the basis of said restored output control information from said output unit.

7. The method according to claim 6, wherein, when said output unit comprises an image display unit, said information for inputting instructions necessary for the operations is provided in the form of an image through which instructions necessary for causing said access device to perform said sequence of operations are input.

8. The method according to claim 7, wherein said information for inputting instructions necessary for the operations provided in the form of the image comprises a link icon.

9. The method according to claim 6, wherein, when said output unit comprises a sound output unit, said information for inputting instructions necessary for the operations is provided in the form of sound with which instructions necessary for causing said access device to perform said sequence of operations are input.

10. The method according to claim 6, wherein said first set of information is basic information and said second set of information is detailed information relating to said basic information, while said third set of information is updating information relating to said basic information.

11. An information acquiring system comprising:
a reading device for optically reading a coded image from a printed matter comprising a first set of information containing at least one of characters, signs, graphics, painted pictures, photographic pictures and computer graphic printed in a form of visually readable and a second set of information obtained by coding data and printed in a form of said coded image optically readable to said reading device, said second set of information being different from said first set of information, wherein said coded image further includes output control information for making an output unit of an access device output information for necessary inputting of instructions for causing said access device to perform a sequence of operations of accessing an external information resource, obtaining a third set of information different from said first and second sets of information from the information resource and making said output unit output said obtained third set of information in a perceivable form at the time of the operation of said reading device optically reading out said coded image, restoring said second set of information from the read out coded image and making said output unit of said access device adapted to access the external information resource by way of a telecommunication network to output said restored second set of information in a perceivable form;
a restoring unit for restoring said second set of information and said output control information from said coded image read by said reading device; and
a control unit for outputting said restored second set of information in a form perceivable from said output unit and also said information for inputting instructions necessary for the above operations on the basis of said restored output control information from said output unit.

12. The system according to claim 11, wherein, when said output unit comprises an image display unit, said information for inputting instructions necessary for the operations is provided in the form of an image through which instructions necessary for causing said access device to perform said sequence of operations are input.

13. The system according to claim 12, wherein said information for inputting instructions necessary for the operations provided in the form of the image comprises a link icon.

14. The system according to claim 11, wherein, when said output unit comprises a sound output unit, said information for inputting instructions necessary for the operations is provided in the form of sound with which instructions necessary for causing said access device to perform said sequence of operations are input.

15. The system according to claim 11, wherein said first set of information is basic information and said second set of information is detailed information relating to said basic information, while said third set of information is updating information relating to said basic information.

16. An information resource to be used with a printed matter comprising a first set of information containing at least one of characters, signs, graphics, painted pictures, photographic pictures and computer graphic printed in a form of visually readable and a second set of information obtained by coding data and printed in a form of a coded image optically readable to a reading device, said second set of information being different from said first set of information, wherein said coded image further includes output control information for making an output unit of an access device output information for necessary inputting of instructions for causing said access device to perform a sequence of operations of accessing said information resource, obtaining a third set of information different from said first and second sets of information from said information resource and making said output unit output said obtained third set of information in a perceivable form at the time of the operation of said reading device optically reading out said coded image, restoring said second set of information from the read out coded image and making said output unit of said access device adapted to access said information resource by way of a telecommunication network to output said restored second set of information in a perceivable form, said second set of information and said output control information being restored as a result of reading said coded image;
said restored second set of information being output in a form perceivable from said output unit, said information for inputting instructions necessary for said operations being output by said output unit according to said restored output control information; and
said information resource being accessed by said access device by way of a telecommunication network by utilizing said information for inputting instructions necessary for said operation output by said output unit,
said information resource comprising:
a communication unit for communicating with said access device by way of said telecommunication network; and
a memory unit for storing said third set of information corresponding to said information for inputting instructions necessary for said operation.

17. A program for causing a computer to realize:
a function of reading a coded image from a printed matter by a reading device and restoring a second set of information and output control information from said coded image read by said reading device, said printed matter comprising a first set of information containing at least one of characters, signs, graphics, painted pictures, photographic pictures and computer graphic printed in a form of visually readable and said second set of information obtained by coding data and printed in a form of said coded image optically readable to said reading device, said second set of information being different from said first set of information, said coded image further including said output control information for making an output unit of an access device output information for necessary inputting of instructions for causing said access device to perform a sequence of operations of accessing an external information resource, obtaining a third set of information different from said first and second sets of information from the information resource and making said output unit output said obtained third set of information in a perceivable form at the time of the operation of said reading device optically reading out said coded image, restoring said second set of information from the read out coded image and making said output unit of said access device adapted to access the external information resource by way of a telecommunication network to output said restored second set of information in a perceivable form; and
a function of outputting said restored second set of information in a form perceivable from said output unit and also said information for inputting instructions necessary for the above operations on the basis of said restored output control information from said output unit.

18. A printed matter comprising:
a first set of information containing at least one of characters, signs, graphics, painted pictures, photographic pictures and computer graphic printed in a form of visually readable image; and
a second set of information obtained by coding data and printed in a form of a coded image optically readable to a reading device, wherein:
said coded image further includes:
output control information for making an output unit of an access device output information for necessary inputting of instructions for causing said access device to perform a sequence of operations of accessing an external information resource, obtaining a third set of information from the information resource and making said output unit output said obtained third set of information at the time of operation of said reading device optically reading out said coded image, restoring said second set of information from the read out coded image and making said access device adapted to access the external information resource by way of a telecommunication network to output said restored second set of information.

19. The printed matter according to claim 18, wherein, when said output unit comprises an image display unit, said information for inputting instructions necessary for the operations is provided in the form of an image through which instructions necessary for causing said access device to perform said sequence of operations are input.

20. The printed matter according to claim 19, wherein said information for inputting instructions necessary for the operations provided in the form of the image comprises a link icon.

21. The printed matter according to claim 18, wherein said third set of information corresponds to said second set of information.

22. An information acquiring method comprising:
reading a coded image from a printed matter by a reading device and restoring a second set of information and output control information from said coded image read by said reading device, said printed matter comprising a first set of information containing at least one of characters, signs, graphics, painted pictures, photographic pictures and computer graphic printed in a form of visually readable image and said second set of information obtained by coding data and printed in a form of said coded image optically readable to said reading device, said coded image further including said output control information for making an output unit of an access device output information for necessary inputting of instructions for causing said access device to perform a sequence of operations of accessing an external information resource, obtaining a third set of information from the information resource and making said output unit output said obtained third set of information at the time of the operation of said reading device optically reading out said coded image, restoring said second set of information from the read out coded image and making said output unit of said access device adapter to access the external information resource by way of a telecommunication network to output said restored second set of information; and
outputting said restored second set of information from said output unit and also said information for inputting instructions necessary for the above operations on the basis of said restored output control information from said output unit.

23. The information acquiring method according to claim 22, wherein, when said output unit comprises an image display unit, said information for inputting instructions necessary for the operations is provided in the form of an image through which instructions necessary for causing said access device to perform said sequence of operations are input.

24. The information acquiring method according to claim 23, wherein said information for inputting instructions necessary for the operations provided in the form of the image comprises a link icon.

25. The information acquiring method according to claim 22, wherein said third set of information corresponds to said second set of information.

26. An information acquiring system comprising,
a reading device for optically reading a coded image from a printed matter comprising a first set of information containing at least one of characters, signs, graphics, painted pictures, photographic pictures and computer graphic printed in a form of visually readable image and a second set of information obtained by coding data and printed in a form of said coded image optically readable to said reading device, wherein said coded image further includes output control information for making an output unit of an access device output information for necessary inputting of instructions for causing said access device to perform a sequence of operations of accessing an external information resource, obtaining a third set of information from the information resource and making said output unit output said obtained third set of information at the time of the operation of said reading device optically reading out said coded image, restoring said second set of information from the read out coded image and making said output unit of said access device adapted to access the external information resource by way of a telecommunication network to output said restored second set of information;
a restoring unit for restoring said second set of information and said output control information from said coded image read by said reading device; and
a control unit for outputting said restored second set of information from said output unit and also said information for inputting instructions necessary for the above operations on the basis of said restored output control information from said output unit.

27. The information acquiring system according to claim 26, wherein, when said output unit comprises an image display unit, said information for inputting instructions necessary for the operations is provided in the form of an image through which instructions necessary for causing said access device to perform said sequence of operations are input.

28. The information acquiring system according to claim 27, wherein said information for inputting instructions necessary for the operations provided in the form of the image comprises a link icon.

29. The information acquiring system according to claim 26, wherein said third set of information corresponds to said second set of information.

30. An information resource to be used with a printed matter comprising a first set of information containing at least one of characters, signs, graphics, painted pictures, photographic pictures and computer graphic printed in a form of visually readable image and a second set of information obtained by coding data and printed in a form of a coded image optically readable to a reading device, wherein said coded image further includes output control information for making an output unit of an access device output information for necessary inputting of instructions for causing said access device to perform a sequence of operations of accessing said information resource, obtaining a third set of information from said information resource and making said output unit output said obtained third set of information at the time of the operation of said reading device optically reading out said coded image, restoring said second set of information from the read out coded image and making said output unit of said access device adapted to access said information resource by way of a telecommunication network to output said restored second set of information, said second set of information and said output control information being restored as a result of reading said coded image;
said restored second set of information being output from said output unit, said information for inputting instructions necessary for said operations being output by said output unit according to said restored output control information; and
said information resource being accessed by said access device by way of a telecommunication network by utilizing said information for inputting instructions necessary for said operations output by said output unit,
said information resource comprising:
a communication unit for communicating with said access device by way of said telecommunication network; and
a memory unit for storing said third set of information corresponding to said information for inputting instructions necessary for said operations.

31. The information resource according to claim 30, wherein, when said output unit comprises an image display unit, said information for inputting instructions necessary for the operations is provided in the form of an image through which instructions necessary for causing said access device to perform said sequence of operations are input.

32. The information resource according to claim 31, wherein said information for inputting instructions necessary for the operations provided in the form of the image comprises a link icon.

33. The information resource according to claim 30, wherein said third set of information corresponds to said second set of information.

34. A program for causing a computer to realize:
a function of reading a coded image from a printed matter by a reading device and restoring a second set of information and output control information from said coded image read by said reading device, said printed matter comprising a first set of information containing at least one of characters, signs, graphics, painted pictures, photographic pictures and computer graphic printed in a form of visually readable image and said second set of information obtained by coding data and printed in a form of said coded image optically readable to said reading device, said coded image further including said output control information for making an output unit of an access device output information for necessary inputting of instructions for causing said access device to perform a sequence of operations of accessing an external information resource, obtaining a third set of information from the information resource and making said output unit output said obtained third set of information at the time of the operation of said reading device optically reading out said coded image, restoring said second set of information from the read out coded image and making said output unit of said access device adapted to access the external information resource by way of a telecommunication network to output said restored second set of information; and
a function of outputting said restored second set of information from said output unit and also said information for inputting instructions necessary for the above operations on the basis of said restored output control information from said output unit.

35. The information resource according to claim 34, wherein, when said output unit comprises an image display unit, said information for inputting instructions necessary for the operations is provided in the form of an image through which instructions necessary for causing said access device to perform said sequence of operations are input.

36. The information resource according to claim 35, wherein said information for inputting instructions necessary for the operations provided in the form of the image comprises a link icon.

37. The information resource according to claim 34, wherein said third set of information corresponds to said second set of information.
